(19) United States
(12) Patent Application Publication
(10) Pub. No.: US 2025/0057133 A1
(43) Pub. Date: Feb. 20, 2025

(54) Fishing Lures

(71) Applicants: David Andrae Justmann, Somerset, WI (US); William David Justmann, Sheboygan, WI (US)

(72) Inventors: David Andrae Justmann, Somerset, WI (US); William David Justmann, Sheboygan, WI (US)

(21) Appl. No.: 18/805,448

(22) Filed: Aug. 14, 2024

Related U.S. Application Data
(60) Provisional application No. 63/520,614, filed on Aug. 19, 2023.

(51) Int. Cl. A01K 85/00; A01K 85/10

(52) U.S. Cl. CPC A01K 85/1841; A01K 85/1837; A01K 85/10

(57) ABSTRACT

Embodiments relate generally to fishing lures, and more particularly to fishing lures that operate behind and to a side of a tip eye of a fishing rod to which they are connected by fishing line while being operated during trolling or being operated from a stream bank. Embodiments include submersible fishing lures and topwater fishing lures.

### CROSS REFERENCE TO RELATED APPLICATION

The present patent application claims priority to U.S. provisional patent application No. 63/520,614 titled “Fishing Lures” filed on Aug. 19, 2023, which is fully incorporated herein by reference.

### TECHNICAL FIELD

Embodiments relate generally to fishing lures, and more particularly to fishing lures that travel behind and to a side of a tip eye of a fishing rod connected to a boat moving along a straight line, thus eliminating the need for a planer board, outrigger, or mast system. Embodiments include fishing lures that operate fully submerged and fishing lures that operate partially submerged.

As used in this disclosure, the noun “echelon” refers to a positional configuration in which one moving object travels behind and to a side of another moving object, as viewed from overhead. A difference or lack of difference in elevation between objects is not implied by the use of the word “echelon” in this disclosure. An example of use of “echelon” as a noun is: “While a boat to which a fishing rod is connected is traveling along a straight line, a fishing lure forms an echelon with a tip eye of the fishing rod to which the fishing lure is connected by fishing line, the fishing lure assuming a position in steady state operation in which it travels behind and to a side of the tip eye of the fishing rod.” As used in this disclosure, the transitive verb “echelon” means to form or arrange in an echelon and the intransitive verb “echelon” means to take position in an echelon. The word “echelon” in this disclosure may also be used as an adjective. An example of use of “echelon” as an adjective is: “While a fishing lure is being trolled, the fishing line to which the fishing lure is attached forms an echelon angle with a course of a tip eye of a fishing rod connected to a boat moving along a straight line.” The word “echeloning” in this disclosure may also be used as an adverb. An example of use of “echeloning” as an adverb is: “The echeloning fishing lure forms an echelon angle with a course of a tip eye of a fishing rod connected to a boat moving along a straight line.”

### BACKGROUND

Anglers trolling for gamefish often use multiple fishing lures spread out to cover a swath of water. Such anglers traditionally use devices such as planer boards, outriggers, or a mast system to spread out the fishing lures in operation. All such devices cost money and add additional complications to trolling.

The need for a submersible fishing lure that operates to a side of a boat's course farther than the tip eye of a fishing rod has been recognized for over one hundred years. A submersible fishing lure (also called a “diving lure” or “crankbait” by anglers) has been known since at least 1914, as illustrated by U.S. Pat. No. 1,182,010 (Heddon). An intermediate device to cause a fishing lure to track farther out to a side of a boat's course has been known since at least 1918, as illustrated by U.S. Pat. No. 1,307,623 (Edmondson). Also in 1918, U.S. Pat. No. 1,307,623 (Phinney) disclosed a diving lure with a means for causing the fishing lure to move sideways. Upper and lower fins were provided above the diving plate (lure lip). The fins are disposed obliquely to give the fishing lure a sideways movement when drawn through the water. However, as is well-known in the art, when a fishing lure travels through the water with more water flowing over one side of a lure lip than over the other, the fishing lure will operate in an unnatural orientation with its vertical axis nonparallel to the direction of gravity and its lateral axis not perpendicular to the direction of gravity.

The need for an effective fishing lure that floats on the water's surface while being retrieved or trolled (called a “topwater fishing lure” by anglers) and operates farther to a side of a boat's course than the tip eye of a fishing rod has been recognized for over one hundred years. U.S. Pat. No. 661,869 (Henkenius) was issued in 1900, disclosing a topwater fishing lure adapted for use in trolling. U.S. Pat. No. 1,361,067 (Jordan) was issued in 1920, disclosing a topwater fishing lure with an eyelet on a side. Jordan taught a topwater fishing lure comprising forward and rear fins, located angularly with regard to each other. Jordan did not teach how to modify the fishing lure to prevent it from operating tilted side-to-side, with the side of the fishing lure side opposite the eyelet becoming higher in elevation than the side the eyelet is on, at higher speeds.

Jordan did not teach that the angle to which his fishing lure went out to a side could be varied by adding additional fishing line attachment features more proximal or more distal on a side of his fishing lure than his side-mounted eyelet, nor did he teach that adding differing tail assemblies would change the resulting echelon angle. Jordan taught away from configurations other than a flat bottomed fishing lure.

During the century since the above-references fishing lure disclosures, an entire industry has evolved, producing better and better planer boards and other devices, to solve the problem of getting a fishing lure positioned out to a side of the course the tip eye of a fishing rod mounted on a moving boat.

There exists a need for an echeloning fishing lure that does not operate in a side-to-side tilted orientation at a predetermined speed. There exists a need for an echeloning submersible fishing lure that rolls in operation about its longitudinal axis with the average orientation of its lateral axis substantially perpendicular to the direction of gravity. There exists a need for an echeloning lure that a user can modify to change an echelon angle to be created by the fishing lure during trolling of the echeloning fishing lure. There exists a need for an echeloning submersible fishing lure that floats while stationary and is submerged in operation during trolling. There exists a need for an echeloning submersible fishing lure that wanders side to side in operation during trolling. There exists a need for an echeloning submersible fishing lure that porpoises up and down in operation during trolling.

The above concise list of examples of needs addressed by embodiments disclosed herein is not an exhaustive list of the needs addressed by embodiments disclosed herein.

Embodiments disclosed herein address such needs for a more effective topwater fishing lure that travels behind and to a side of a tip eye of a fish rod connected to a boat traveling along a straight line, eliminating the need for a planer board, outrigger, or mast system.

Embodiments disclosed herein address such needs for a submersible fishing lure that operates behind and to a side of a tip eye of a fish rod connected to a boat traveling along a straight line, eliminating the need for a planer board, outrigger, or mast system. The connection of the fishing rod to the boat may be indirect connection, for example, a rod holder or a human being holding the fishing rod while on the boat.

### SUMMARY

Embodiments described or otherwise contemplated herein substantially meet the aforementioned needs.

Fishing lures embodying subject matter disclosed herein comprise a proximal end, a distal end, a longitudinal axis extending between the proximal end and the distal end, a proximal end region, a distal end region, a middle region, a lateral axis substantially perpendicular to the longitudinal axis, a vertical axis substantially perpendicular to the longitudinal axis, a first side, a second side, a top side, a bottom side, and a lure body. The lure body comprises a proximal end, a proximal end surface, a proximal end region, a distal end, a distal end region, a middle region, a top surface, a bottom surface, a first side surface, and a second side surface. The lure body has a longitudinal axis extending between its proximal end and its distal end, which may be substantially equidistant between the first side surface and the second side surface in the middle region; a vertical axis extending between the top surface of the lure body and the bottom surface of the lure body, substantially perpendicular to the longitudinal axis; and a lateral axis extending between the first side surface and the second side surface, substantially perpendicular to the longitudinal axis. The first side of the fishing lure is on the same side of the fishing lure as the first side surface of the lure body is. The second side of the fishing lure is on the same side of the fishing lure as the second side surface of the lure body is. The top side of the fishing lure is on the same side of the fishing lure as the top surface of the lure body is. The bottom side of the fishing lure is on the same side of the fishing lure as the bottom surface of the lure body is. In an embodiment, the longitudinal axis of the fishing lure and the longitudinal axis of the lure body may be the same.

A fishing lure embodying subject matter disclosed herein further comprises at least one keel in a proximal end region of the lure body. The keel comprises a first side surface, a second side surface, a proximal end surface, a distal end surface, a top surface, and a bottom surface. In embodiments incorporating a plurality of keels in the proximal end region, the side surfaces of the keels may be substantially parallel to each other. One or more keels can optionally be provided in a distal end region.

A fishing lure embodying subject matter disclosed herein further comprises at least one fishing line connection feature, such as an eye or a loop, along a side of the fishing lure for connecting a fishing line or connecting an intermediate device connected to a fishing line, such as a split ring or snap. A fishing lure preferably provides at least one fishhook connection feature, such as an eye or a loop, for connecting a fishhook or connecting an intermediate device, such as a split ring.

As used in this disclosure in the context of trolling, the “near side” of a fishing lure or part of a fishing lure refers to the side that is closer to the course of a tip eye of a fishing rod to which the fishing lure is connected by fishing line during operation of the fishing lure. For the sake of clarity, the “near side” of a fishing lure or part of a fishing lure is the side on which a fishing line is attached by a user and the “far side” of a fishing lure or part of a fishing lure is the side opposite the “near side”.

With reference to a submersible fishing lure embodying subject matter disclosed herein, at least one balance weight may be provided in the proximal end region of the fishing lure to cause the proximal end of the lure body to pitch downward when the fishing lure is placed in a stationary position on the surface of the water, resulting in the proximal end of the top surface of the lure body being submerged. The balance weight may be, for example, in or on the lure body, may be in or on the keels, or may be the keels themselves. Optionally, alone or in combination with the balance weight, a diving lip may be provided in the proximal end region of the fishing lure. Many such diving lips are well known in the art and are available in many sizes and shapes, and when added to echeloning submersible fishing lures can modify the action and/or diving depth of the fishing lures. Several suitable diving lips are available from lure parts retailers, including LurePartsOnline.com and barstowtackle.com.

In preparation for operation, a submersible fishing lure may be placed on the surface of the water in a static position. The fishing lure floats in a static position with its longitudinal axis lower in elevation at the proximal end of the lure body than the longitudinal axis is at the distal end of the lure body. The proximal end of the lure body is submerged. As the fishing lure is pulled forward in operation, the fishing lure dives below the surface of the water.

In another embodiment, the entire fishing lure may sink while in a static position. A buoyant tail assembly may be attached to the fishing lure prior to use to cause the combined fishing lure assembly to float in a static position with the longitudinal axis of the lure body lower in elevation at the proximal end of the lure body than the longitudinal axis is at the distal end of the lure body. As the combined fishing lure assembly is pulled forward in operation, the fishing lure dives below the surface of the water.

Water moving over the pitched top surface of the lure body causes the fishing lure or combined fishing lure assembly to submerge and remain submerged during operation. Optionally, a suitable lure lip may be provided in the proximal end region of the fishing lure to cause, or assist in causing, the fishing lure to submerge and remain submerged during operation.

In preparation for operation, a submersible fishing lure or a topwater fishing lure disclosed herein is connected to a fishing line, which in turn is connected to a fishing rod though a tip eye. The fishing lure is placed on the surface of the water. As the boat carrying the fishing rod moves forward in operation and fishing line connected to a fishing rod connected to the boat is released at a rate slower than the speed of the boat, water moving past the fishing lure causes it to move away from course of the tip eye of the fishing rod. Given that the fishing rod is connected to the boat, the course of the tip eye of the fishing rod is parallel to the centerline of the course of the boat while the boat is travelling along a straight line. As more fishing line is released from the fishing rod under controlled tension, the fishing lure travels further behind the tip eye of the fishing rod and further to the side of the course of the tip eye of the fishing rod. Once the fishing lure reaches a desired distance from the tip eye of the fishing rod, the process of releasing additional fishing line stops and the fishing lure begins operating in a steady state position relative to the tip eye of the fishing rod. In its steady state position, the fishing lure has formed an echelon with the tip eye of the fishing rod and formed an echelon angle in the horizontal plane between the fishing line and course of the tip eye of the fishing rod. A fishing lure that, for example, creates a 30-degree echelon angle in the horizontal plane between the fishing line and the course of the tip eye of the fishing rod may be referred to simply as a “30 degree fishing lure”.

In an embodiment, a user may prefer an echeloning fishing lure with supplemental action created by a tail assembly installed in place of a fishhook at the distal end of the fishing lure. By selecting a tail assembly with substantially more drag than the fishhook it replaces, such a combined fishing lure assembly decreases the resulting echelon angle in operation. The increased drag can, for example, be used to change a 30 degree fishing lure to a 15 degree combined fishing lure assembly. Another way in which to provide echeloning fishing lures with differing echelon angles is to provide multiple fishing line connection features along a side of the fishing lure, such as along a side of the lure body or a side of a keel.

In an embodiment, a submersible fishing lure with keel(s) having side surfaces at an angle to the longitudinal axis of the fishing lure wanders side to side in operation. The keels, and in an embodiment, the secondary far side surface of the lure body, steer the submersible fishing lure to a side of the fishing lure's course centerline to an unsustainable, unstable position. The fishing lure corrects and wanders closer to the course of the tip eye of the fishing rod to which the fishing lure is connected by fishing line. In this position, the fishing lure has crossed its course centerline and is on the opposite side of it. The fishing lure now starts to wander, and continues to wander, back across the fishing lure's centerline until it again reaches another unsustainable, unstable position and then repeats the wandering cycle.

In an embodiment, a submersible fishing lure porpoises in operation under water. The amount of balance weight and its position may be provided such that the echeloning fishing lure dives while moving forward until it reaches an unsustainable, unstable position as the boat bobs up and down and/or the fishing rod flexes. The fishing lure corrects and rises upward while moving forward until it reaches another unsustainable, unstable position. The fishing lure now starts to dive again, and continues to dive, back down until it again reaches another unsustainable, unstable position and then repeats the cycle.

In an embodiment, an echeloning topwater lure proceeds along a substantially straight-line course behind and to a side of a tip eye of a fishing rod connected to a boat moving along a straight line.

In an embodiment, an echeloning topwater lure zigzags side-to-side along a course centerline, the topwater lure traveling behind and to a side of a tip eye of a fishing rod connected to a boat moving along a straight line. The echeloning fishing lure achieves its greatest echelon angle while its keel in the proximal end region of the fishing lure is entirely engaged with the water. When, for example, the fishing lure tops a wave crest and/or the boat to which the fishing rod is connected rocks, the keel of the fishing lure becomes partially or wholly disengaged from the water and fishing line tension causes it to veer toward the boat. Once the keel is again fully engaged with the water, the fishing lure again heads toward its maximally achievable echelon angle. When its keel again becomes partially or wholly disengaged with the water, fishing line tension again causes it to veer toward the boat's course centerline. Anglers sometimes colloquially refer to such zigzagging as “walking the dog”. In an embodiment, the zigzagging does not follow a symmetrical waveform path, but rather is erratic.

The above example of echeloning topwater lures in operation is not exhaustive. Combination thereof and variations thereof are within the spirit and scope of this disclosure.

A list of several exemplary uses of echeloning fishing lures follows. These uses are not mutually exclusive and this is not an exhaustive list.

As will be appreciated by anglers who use electronic devices, for example sonar, to detect fish to a side of a boat as they troll, the length of fishing line connected to an echeloning lure that is already operating in the water to the side and behind of the tip eye of a fishing rod can be increased or decreased by the angler to alter the fishing lure's course to pass closer to a fish that has been detected by an electronic device.

As will be appreciated by anglers who pursue fish that are sensitive to disturbance from a moving boat, an echeloning fishing lure may be operated out to a side of the swath of water that the boat disturbs while in motion.

As will be appreciated by anglers who fish along weed bed edges along shorelines, an echeloning topwater fishing lure may be trolled parallel to a shoreline such that its course approximates the inside edge of a weed bed or be trolled over submerged trees that have fallen into the water from shore.

As will be appreciated by anglers who attempt to catch fish by casting over the top of a submerged weed bed that parallels a shoreline, an echeloning topwater may be presented to the fish generally perpendicular to the direction that the fish are accustomed to detecting fishing lures traveling over the submerged weed bed. For example, an angler using a conventional fishing lure in a boat following the deep (outside) edge of a weed bed typically casts to a side of the boat. An echeloning fishing lure can be operated by trolling it from a boat following the same course as the boat of the angler that is using a conventional fishing lure, but the presentation of the echeloning fishing lure to the fish will be generally perpendicular to the presentations they observed from the angler using a convention fishing lure.

As will also be appreciated by anglers who troll along the deep edge of a weed bed, a conventional diving fishing lure may be trolled along a course outside the deep edge of the weed bed, an echeloning submersible fishing lure may be trolled along a course over the short weeds where the weed edge tapers off as the bottom contour of the water body descends, and an echeloning topwater fishing lure may be trolled over the top of the weed bed, all at the same time.

As will be appreciated by anglers who fish over large weed beds, multiple echeloning topwater fishing lures may be trolled simultaneously over the top of a submerged weed bed to simultaneously cover a swath of water.

As will be appreciated by anglers who fish open water, multiple echeloning submersible fishing lures may be trolled simultaneously to cover a swath of open water.

As will be appreciated by anglers who troll during an insect hatch, porpoising (moving up and down while also moving forward) submersible fishing lures may be operated to simulate fish feeding on insects as they rise toward the surface of the water.

As will be appreciated by anglers who fish from a stream bank, an echeloning fishing lure may be operated by casting it from a stream bank, maintaining the echeloning fishing lure in a steady state position in the stream's current, optionally jigging it forward periodically, and retrieving it back to the stream bank to cover a band of water.

As will be appreciated by anglers who fish through ice over a moving stream, a pair of echeloning submersible fishing lures, one constructed opposite hand of the other, may be operated through a single hole drilled through the ice.

It will also be appreciated by those skilled in the art that the lure body and/or buoyant tail assembly or portions thereof may be constructed from any buoyant material(s), including wood, plastic, or combinations thereof. The keel(s), balance weight(s), fish hook connection feature(s), and fishing line connection feature(s) may be separate components assembled to the lure body or may be formed unitary with the lure body in one piece.

The above summary is not necessarily intended to describe each illustrated embodiment or every implementation of the subject matter hereof. The FIGS. and the detailed description that follow more particularly exemplify these embodiments.

### BRIEF DESCRIPTION OF THE DRAWINGS

Subject matter hereof may be more completely understood in consideration of the following detailed description of various embodiments of the subject matter in connection with the accompanying drawings, in which:

FIG. 1 illustrates a side view of an exemplary submersible fishing lure embodying subject matter disclosed herein;

FIG. 2 illustrates a bottom view of an exemplary submersible fishing lure embodying subject matter disclosed herein;

FIG. 3 illustrates a view along line A-A of FIG. 2 illustrating an exemplary submersible fishing lure embodying subject matter disclosed herein, shown with the split rings and fishhooks removed;

FIG. 4 illustrates a side view of an exemplary submersible fishing lure embodying subject matter herein, in which the keels and lure body are formed together in one piece;

FIG. 5 illustrates a bottom view of an exemplary submersible fishing lure embodying subject matter herein, in which the keels and lure body are formed together in one piece;

FIG. 6 illustrates a view along line B-B of FIG. 5 illustrating an exemplary submersible fishing lure embodying subject matter disclosed herein, in which the keels and lure body are formed together in one piece, shown with the split rings and fishhooks removed;

FIG. 7 illustrates a side view of another exemplary submersible fishing lure embodying subject matter disclosed herein;

FIG. 8 illustrates a bottom view of the another exemplary submersible fishing lure embodying subject matter disclosed herein;

FIG. 9 illustrates a side view of yet another exemplary submersible fishing lure embodying subject matter disclosed herein;

FIG. 10 illustrates a bottom view of the yet another exemplary submersible fishing lure embodying subject matter disclosed herein;

FIG. 11 illustrates a view along line C-C of FIG. 10 illustrating the yet another exemplary submersible fishing lure embodying subject matter disclosed herein, shown with the split rings and fishhooks removed;

FIG. 12 illustrates a side view of an exemplary topwater fishing lure embodying subject matter disclosed herein;

FIG. 13 illustrates a bottom view of an exemplary topwater fishing lure embodying subject matter disclosed herein;

FIG. 14 illustrates a view along line D-D of FIG. 13 illustrating an exemplary topwater fishing lure embodying subject matter disclosed herein, shown with the split rings and fishhooks removed;

FIG. 15 illustrates a side view of an exemplary topwater fishing lure embodying subject matter herein in which the keels and lure body are formed together in one piece;

FIG. 16 illustrates a bottom view of an exemplary topwater fishing lure embodying subject matter herein in which the keels and lure body are formed together in one piece;

FIG. 17 illustrates a view along line E-E of FIG. 16 illustrating an exemplary topwater fishing lure embodying subject matter disclosed herein in which the keels and lure body are formed together in one piece, shown with the split rings and fishhooks removed;

FIG. 18 illustrates a side view of another exemplary topwater fishing lure embodying subject matter disclosed herein;

FIG. 19 illustrates a bottom view of the another exemplary topwater fishing lure embodying subject matter disclosed herein;

FIG. 20 illustrates a view along line F-F of FIG. 19 illustrating the another exemplary topwater fishing lure embodying subject matter disclosed herein, shown with the split rings and fishhooks removed;

FIG. 21 illustrates a side view of yet another exemplary topwater fishing lure embodying subject matter disclosed herein;

FIG. 22 illustrates a bottom view of the yet another exemplary topwater fishing lure embodying subject matter disclosed herein;

FIG. 23 illustrates a view along line G-G of FIG. 22 illustrating the yet another exemplary topwater fishing lure embodying subject matter disclosed herein, shown with the split rings and fishhooks removed;

FIG. 24 illustrates a side view of a further exemplary topwater fishing lure embodying subject matter disclosed herein;

FIG. 25 illustrates a bottom view of the further exemplary topwater fishing lure embodying subject matter disclosed herein;

FIG. 26 illustrates a side view of a convertible echeloning fishing lure embodying subject matter disclosed herein;

FIG. 27 illustrates a bottom view of the convertible echeloning fishing lure embodying subject matter disclosed herein;

FIG. 28 illustrates an end view of the convertible echeloning fishing lure embodying subject matter disclosed herein, shown with the split rings and fishhooks removed;

FIG. 29 illustrates a tail assembly embodying subject matter disclosed herein that may be installed on fishing lure embodiments disclosed herein in place of a fishhook at the distal end of fishing lure embodiments disclosed herein;

FIG. 30 illustrates a tail assembly embodying subject matter disclosed herein that may be installed on fishing lure embodiments disclosed herein in place of a fishhook at the distal end of fishing lure embodiments disclosed herein;

FIG. 31 illustrates a tail assembly embodying subject matter disclosed herein that may be installed on fishing lure embodiments disclosed herein in place of a fishhook at the distal end of fishing lure embodiments disclosed herein;

FIG. 32 illustrates a tail assembly embodying subject matter disclosed herein that may be installed on fishing lure embodiments disclosed herein in place of a fishhook at the distal end of fishing lure embodiments disclosed herein;

FIG. 33 illustrates a top view of another tail assembly that may be installed on fishing lure embodiments disclosed herein in place of a fishhook and fishhook attachment feature at the distal end of fishing lure embodiments disclosed herein;

FIG. 34 illustrates a side view of the tail assembly illustrated in FIG. 33;

FIG. 35 illustrates an enlarged end view of the tail assembly illustrated in FIGS. 33 and 34;

FIG. 36 illustrates a schematic plan view of a method of operating echeloning fishing lures embodying subject matter disclosed herein;

FIG. 37 illustrates a schematic plan view of a method of operating a conventional topwater fishing lure at the same time as operating two echeloning topwater fishing lures embodying subject matter disclosed herein;

FIG. 38 illustrates a schematic plan view of a method of simultaneously operating a conventional submersible fishing lure and two echeloning submersible fishing lures embodying subject matter disclosed herein;

FIG. 39 illustrates a schematic front view of a method of simultaneously operating a conventional submersible fishing lure, an echeloning submersible fishing lure, and an echeloning topwater fishing lure embodying subject matter disclosed herein;

FIG. 40 illustrates a schematic plan view of the method illustrated in FIG. 39;

FIG. 41 illustrates a side view of an echeloning topwater fishing lure embodying subject matter disclosed herein, configured to be operated by a user off either the port side or the starboard side of a boat, whichever side the user prefers to operate it off;

FIG. 42 illustrates a bottom view of the echeloning topwater fishing lure embodying subject matter disclosed herein, configured to be operated by a user off either the port side or the starboard side of a boat, whichever side the user prefers to operate it off;

FIG. 43 illustrates an end view of the echeloning topwater fishing lure embodying subject matter disclosed herein, configured to be operated by a user off either the port side or the starboard side, whichever side of a boat the user prefers to operate it off, shown with the split rings and fishhooks removed;

FIG. 44 illustrates a side view of an exemplary “walking the dog” topwater fishing lure embodying subject matter disclosed herein;

FIG. 45 illustrates a bottom view of the exemplary “walking the dog” topwater fishing lure embodying subject matter disclosed herein;

FIG. 46 illustrates an end view of the exemplary “walking the dog” topwater fishing lure embodying subject matter disclosed herein, shown with the split rings and fishhooks removed;

FIG. 47 illustrates a side view of a “flap tail” fishing lure embodying subject matter disclosed herein;

FIG. 48 illustrates a bottom view of the “flap tail” fishing lure embodying subject matter disclosed herein;

FIG. 49 illustrates a side view of another “flap tail” fishing lure embodying subject matter disclosed herein; and

FIG. 50 illustrates a bottom view of the another “flap tail” fishing lure embodying subject matter disclosed herein.

The fishing lures illustrated in the FIGS. 1-25 may be manufactured according to mirror images of the illustrations to produce opposite hand lures.

While particular embodiments illustrated in some FIGS. have two or three keels, it is to be understood that embodiments may have a single keel or have more than three keels. In an embodiment, the angle of the keel(s) relative to the sides of the fishing lure may be modified, such as, for example, to configure a fishing lure to create a different echelon angle or different amplitude of side to side wandering. Furthermore, while certain embodiments shown are assembled from multiple individual components, components may be formed together, such as by molding, machining, 3D printing, or other manufacturing process.

While particular embodiments are amenable to various modifications and alternative forms, specifics thereof have been shown by way of example in the drawings and will be described in detail. It should be understood, however, that the intention is not to limit subject matter hereof to the particular embodiments described. On the contrary, the intention is to cover all modifications, equivalents, and alternatives falling within the spirit and scope of subject matter hereof in accordance with the appended claims. A scale of embodiments is not implied by, and is not to be inferred from, the illustrations. The embodiments may be scaled suitably to a size desired by the maker of the fishing lure.

### DETAILED DESCRIPTION

Fishing lures described in greater detail by way of example herein form an echelon with the tip eye of a fishing rod to which the fishing lure is connected by fishing line while being trolled from a boat. Embodiments include submersible fishing lures and topwater fishing lures. Also disclosed are methods of using echeloning fishing lures.

Referring now to FIGS. 1-3, a submersible fishing lure 10 comprises a proximal end 11, a distal end 13, and a proximal end region 19. The fishing lure 10 has a longitudinal axis extending between its proximal end 11 and its distal end 13. The fishing lure 10 further comprises a lure body 12 comprising a proximal end 14, a proximal end surface 15, a proximal end region 16, a distal end 18, a distal end region 20, a middle region 53, a top surface 22, and a bottom surface 24. The lure body 12 has a longitudinal axis extending between its proximal end 14 and its distal end 18 and a vertical axis extending between top surface 22 and bottom surface 24.

Lure body 12 may also comprise a beveled surface 17 to, for example, lower resistance of fishing lure 10 moving through water. Beveled surface 17 may in turn adjoin bottom surface 24. In an embodiment, beveled surface 17 may form an angle with bottom surface 24, as illustrated. In an embodiment, beveled surface 17 may be curved to provide a smooth transition to bottom surface 24. An example of material from which the lure body may be fabricated is cedar, though other wood, and/or other materials including plastic may be used alone or in conjunction with wood or other material(s).

The fishing lure 10 further comprises at least one keel 26 in the proximal end region 16. The fishing lure 10 may further comprise at least one additional keel 28, spaced apart from keel 26, in the proximal end region 16. An example of material from which the keel may be fabricated is aluminum flat bar though other materials, including plastic, may be used alone or in combination with other material(s). The keels may be substantially planar or may be bent such that keel top surface 27 and keel top surface 29 are closer together than those keels are where they join the lure body. Similarly, the keels may be bent such that keel bottom surface 31 and keel bottom surface 33 are closer together than those keels are where they join the lure body. In embodiments in which the keels are made, for example, from aluminum flat bar, the corners and edges of the keels may be are rounded, for example with a metal file or grinder, so that, for example, fishing line to which the fishing lure is attached is less likely to get cut when it comes into contact with the corners and edges. Additional material may be removed from the corners to a create rounded corners pleasing to the fishing lure maker. If instead, for example, the keels are molded or 3D printed, the corners and edges may be formed rounded.

Keel 26 may be held on by fasteners 30 and 32, such as screws. Fastener 30 and/or fastener 32 may also comprise a fishing line connection feature, such as a screw eye. Alternatively, the fishing line connection feature may be in addition to the fasteners and be, for example, an eye or a loop. Although fasteners are illustrated as holding on the keel, the keel may be glued onto the lure body or the keel may be formed unitary with the lure body.

A balance weight 34 may be provided on bottom surface 24. An example of a balance weight is a round lead disk with a clearance hole through its center. Balance weight 34 may be fastened to lure body 12 with a fastener 36. However, the balance weight may instead be molded into the lure body or attached to the lure body by other means, such as an adhesive. Fastener 36 may comprise a fishhook attachment feature, such as a screw eye or a loop. A fishhook 40 may be connected to the fishhook attachment feature directly or indirectly, such as by a split ring 38.

A fishhook attachment feature 42 may be provided at distal end 18 of lure body 12. The fishhook attachment feature 42 may be, for example, a screw eye or a loop. A fishhook 46 may be connected to the fishhook attachment feature, directly or indirectly, such as by a split ring 44.

Fishing lure 10 further comprises a proximal end region 19 and a distal end region 21. Fishing lure 10 further comprises a lure body 12 comprising a near side surface 50, a far side surface 52, a near side intermediate portion 91 of near side surface 50, and a distal end surface 68. In an embodiment, the longitudinal axis of the fishing lure 10 may be substantially equidistant between near side surface 50 and far side surface 52 in middle region 53.

Keel 28 may be fastened to lure body 12 with fasteners 54 and 56. Although fasteners are illustrated as holding on the keel, the keel may be glued on or formed unitary with the lure body. Keel 26 comprises a proximal end surface 35 and a distal end surface 37. Keel 28 comprises a proximal end surface 39 and a distal end surface 41. Keels 26 and 28 are illustrated with their proximal end surfaces offset from each. In an embodiment, the distance of the offset may less than illustrated and may even be such that a carpenter's square positioned against the near side surface 43 of the near side keel 26 would touch the proximal end surfaces of both keels 26 and 28.

A split ring 58 may optionally be attached to fastener 30. A split ring 60 may optionally be attached to fastener 32. A third split ring 62 may be attached to split rings 58 and 60 to provide the user with five fishing line connection points to choose from based on the fishing lure action desired in operation.

Optional holes 64 and 66 may be provided to allow repositioning of balance weight 34, fishhook attachment feature 36, optional split ring 38, and fishhook 40 to adjust operation of the fishing lure to achieve various operating depth, porpoising, and trolling speed combinations.

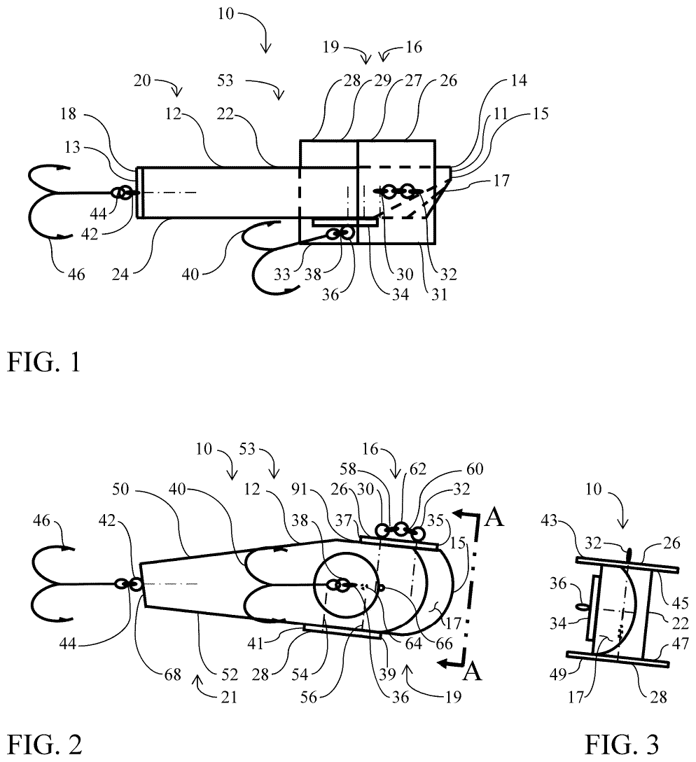

FIG. 3 is a view along line A-A of FIG. 2, shown with the fishhooks and split rings removed from fishing lure 10. Keel 26 comprises a near side surface 43 and a far side surface 45. Keel 28 comprises a near side surface 47 and a far side surface 49.

In preparation for operation, fishing lure 10 is connected to a fishing line which in turn is connected to a fishing rod connected to a boat. The fishing rod comprises a tip eye at its distal end (the end opposite the butt end of the rod). The fishing lure floats in a static position with its longitudinal axis lower in elevation at the proximal end of the lure body than the longitudinal axis at the distal end of the lure body. The proximal end of the lure body is submerged. As the fishing lure 10 is moved forward in operation, the fishing lure dives below the surface of the water, driven downward by water moving over top surface 22 which is oriented in a downward pitched orientation. In steady state, the fishing lure 10 operates to a side of the course of the tip eye of the fishing rod in an echelon position with the tip eye. In another embodiment, the entire fishing lure sinks while in a static position and can optionally be suspended by the buoyancy of a tail assembly.

The distance behind and to the side of the tip eye of the fishing rod and depth of the fishing lure in operation at a selected speed are controlled by the length of fishing line released from the fishing rod. With balance weight 34 in a predetermined position, more line is released at higher trolling speeds to keep the fishing lure submerged in operation. Balance weight 34 may be repositioned to a hole closer to the proximal end of the fishing lure to decrease the length of fishing line needed to be released in order to keep the fishing lure submerged during operation.

In an embodiment, in which fishhook attachment feature 36 comprises a screw eye and holds balance weight 34 to the lure body 12, the vertical position of balance weight 34 may be adjusted by turning fishhook attachment feature 36 to partially back it out of its hole in the lure body 12 to lower the balance weight 34, resulting in decreased rolling action of the fishing lure 10 in operation. A user having a preferred setting for the distance between bottom surface 24 and balance weight 34 may unscrew the screw eye, slip a plastic sleeve of corresponding length over a portion of the screw, and screw the screw eye back into the lure body to maintain the distance at which balance weight 34 is away from bottom surface 24.

In operation of an embodiment, the fishing lure is placed on the surface of the water. The fishing lure floats with the proximal end of the lure body lower in elevation than the distal end of the lure body and the proximal end of the lure body is submerged. As the fishing lure is pulled forward, the fishing lure dives below the surface of the water. As the fishing lure is subjected to tension from the fishing line, water moving over the pitched top surface of the lure body causes the fishing lure to submerge (if it is not already submerged) and remain submerged during operation. Optionally, a suitable lure lip may be assembled to the proximal end region of the fishing lure to cause, or assist in causing, the fishing lure to submerge and remain submerged during operation.

With the fishing lure connected to a very short length of fishing line released from a fishing rod that has a tip eye higher in elevation than the depth at which the fishing lure is operating, the upward component of the fishing line tension causes the fishing lure to tilt with the near side surface of the lure body higher than the far side surface of the lure body. In this orientation, the near side surfaces of the keels steer the fishing lure both to a side and downward. As more and more fishing line is released, the fishing lure begins to operate with the lateral axis of the lure body closer and closer to substantially perpendicular to the direction of gravity. With a longer length of fishing line released, the side-to-side rolling action of the fishing lure is substantially symmetrical about the longitudinal axis of the lure body and the average orientation of the fishing lure is such that the lateral axis of the lure body is substantially perpendicular to the direction of gravity. To decrease the length of fishing line needed to first reach a position with side-to-side rolling symmetry, the screw eye holding the balance weight to the lure body can be loosened, the balance weight moved laterally along the bottom surface of the lure body toward the near side keel (taking advantage of a clearance hole through the balance weight), and the screw eye retightened.

A user may prefer to install a bead on the fishing line at a predetermined distance from the fishing lure to use as a reference to estimate the fishing lure's position under water. A user may find this particularly helpful when precise operating depth is desired, such as when operating the fishing lure by trolling it over the tops of submerged weeds or when operating the fishing lure just below the surface to mimic a fish feeding during a bug hatch.

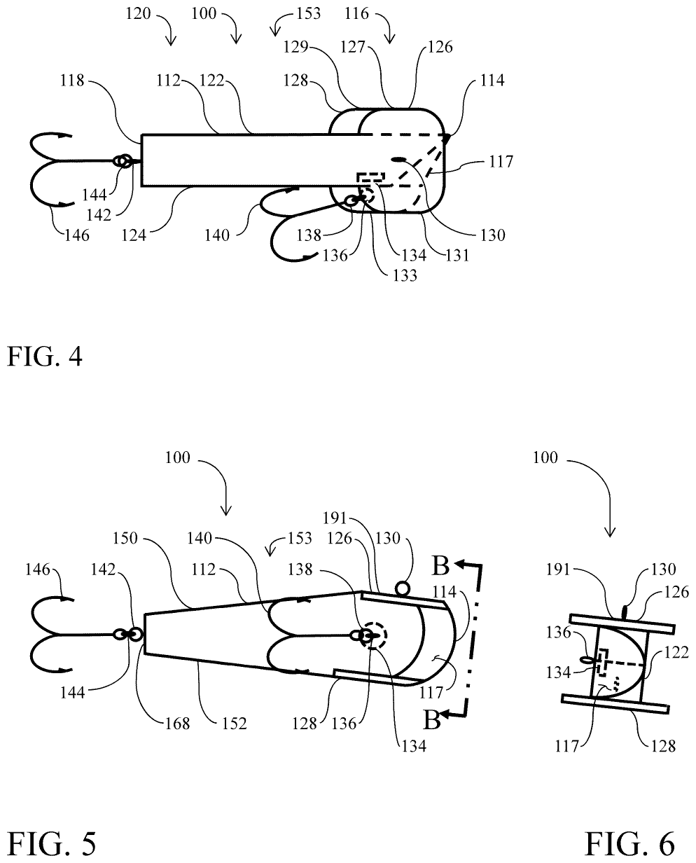

Referring now to FIGS. 4-6 illustrating an embodiment of an echeloning submersible fishing lure in which the keel(s) and lure body are formed together in one piece, a fishing lure 100 comprises a lure body 112 comprising a proximal end 114, a proximal end region 116, a distal end 118, a distal end region 120, a middle region 153, a top surface 122, and a bottom surface 124. Lure body 112 may also comprise a beveled surface 117 to, for example, lower resistance of fishing lure 100 moving through water. Beveled surface 117 may in turn adjoin bottom surface 124. In an embodiment, beveled surface 117 may form an angle with bottom surface 124, as illustrated. In an embodiment, beveled surface 117 may be curved to provide a smooth transition to bottom surface 124.

The fishing lure 100 further comprises at least one keel 126 in the proximal end region 116. The fishing lure may further comprise at least one additional keel 128, spaced apart about the longitudinal axis of the lure body 112 from keel 126, in the proximal end region 116. In some embodiments, the keels may be spaced closer together than illustrated. The keels may be substantially planar or be formed in a bent shape such that keel top surface 127 and keel top surface 129 are closer together than those keels are where they join the lure body. Similarly, the keels may be formed in a bent in shape such that keel bottom surface 131 and keel bottom surface 133 are closer together than those keels are where they join the lure body.

Keels 126 and 128 are formed together with lure body 112 in one piece. A balance weight 134 may be provided at or near bottom surface 124. A fishhook attachment feature 136 may be provided on bottom surface 124. A fishhook 140 may be connected to fishhook attachment feature 136 directly or indirectly, such as by a split ring 138.

A fishhook attachment feature 142 may be provided at the distal end 118 of lure body 112. The fishhook attachment feature 142 may, for example, be an eye or a loop. A fishhook 146 may be connected to the fishhook attachment feature directly or indirectly, such as by a split ring 144.

Lure body 112 further comprises a near side surface 150, a far side surface 152, a near side intermediate portion 191 of near side surface 150, and a distal end surface 168. In an embodiment, the longitudinal axis of the fishing lure 100 may be substantially equidistant between near side surface 150 and far side surface 152 in middle region 153. A fishing line attachment feature 130 is provided along near side surface 150 of the lure body 112 and may, for example, be an eye or a loop.

FIG. 6 is a view along line B-B of FIG. 5, shown with the fishhooks and split rings removed from the fishing lure 100.

In an embodiment, a fishing lure is manufactured as illustrated in FIGS. 4-6, except it comprises less than two keels. In an embodiment, a fishing lure is manufactured as illustrated in FIGS. 4-6, except it comprises more than two keels.

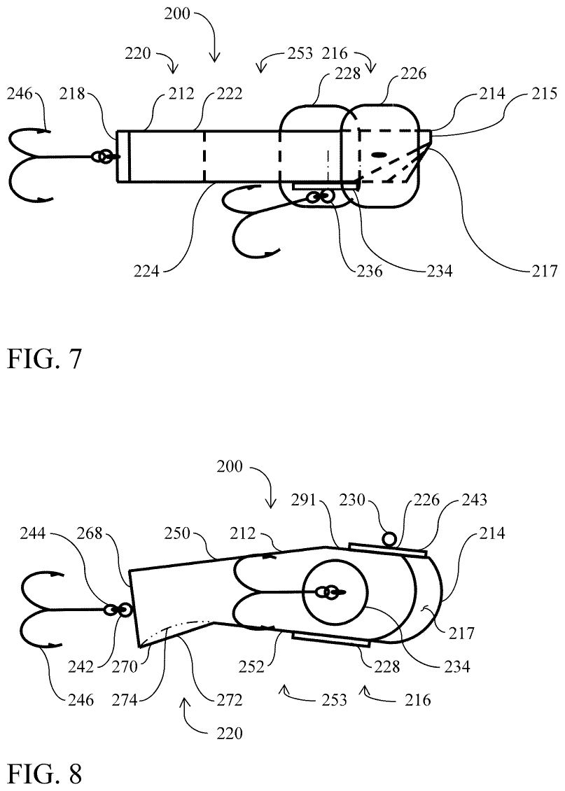

Referring now to FIGS. 7-8, an echeloning submersible fishing lure 200 comprises a lure body 212. Lure body 212 comprises a proximal end 214, a proximal end region 216, a proximal end surface 215, a distal end 218, a distal end region 220, a middle region 253, a top surface 222, and a bottom surface 224. Lure body 212 may also comprise a beveled surface 217. Proximal end surface 215 may adjoin a beveled surface 217 to, for example, lower resistance of fishing lure 200 moving through water. Beveled surface 217 may in turn adjoin bottom surface 224. In an embodiment, beveled surface 217 may form an angle with bottom surface 224, as illustrated. In an embodiment, beveled surface 217 may be curved to provide a smooth transition to bottom surface 224.

The fishing lure 200 further comprises at least one keel 226 in the proximal end region 216. The fishing lure may further comprise at least one additional keel 228, spaced apart from keel 226, in the proximal end region 216. A balance weight 234 may be provided on bottom surface 224. The balance weight 234 may connected to bottom surface 224 by a fishhook connection feature 236, such as a screw eye, or balance weight 234 may be unitary with the lure body 212.

Lure body 212 further comprises a proximal end 214, a near side surface 250, a far side surface 252, a near side intermediate portion 291 of near side surface 250, and a distal end surface 268. In an embodiment, the longitudinal axis of the fishing lure 200 may be substantially equidistant between near side surface 250 and far side surface 252 in middle region 253. Keel 226 comprises a near side surface 243. At least one fishing line attachment feature 230 is provided along near side surface 243 of keel 226. In distal end region 220, top surface 222, and bottom surface 224 flare toward the far side, creating secondary far side surface 270. Secondary far side surface 270 may be an angled surface 272 or may be a curved surface 274.

A fishhook attachment feature 242 may be provided at the distal end 218 of lure body 212. The fishhook attachment feature 242 may, for example, be an eye or a loop. A fishhook 246 may be connected to the fishhook attachment feature directly or indirectly, such as by a split ring 244.

In operation, the secondary far side surface is subjected to more resistance in the water than if it were not protruding out from far side surface 252. The force of the increased resistance causes the proximal end 214 to be turned further away from the fishing line to which the fishing lure is connected than if the secondary far side surface were not provided. This results in a greater echelon angle achievable by the fishing lure in operation than a fishing lure without a secondary side surface 220.

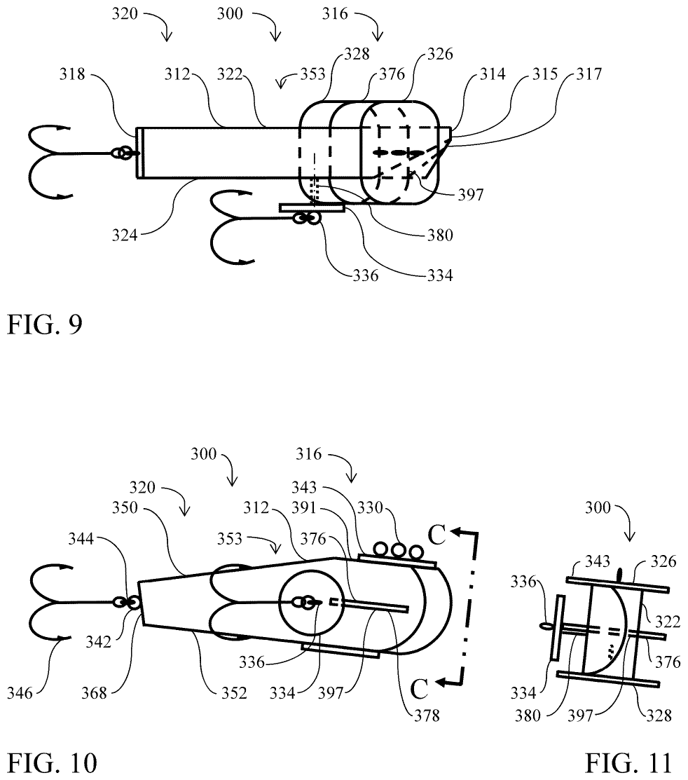

Referring now to FIGS. 9-11 illustrating an embodiment of an echeloning submersible fishing lure comprising three keels, a fishing lure 300 comprises a lure body 312. Lure body 312 comprises a proximal end 314, a proximal end surface 315, a proximal end region 316, a distal end 318, a distal end region 320, a middle region 353, a top surface 322, a bottom surface 324 and a through slot 397. Lure body 312 may also comprise a beveled surface 317. Proximal end surface 315 may adjoin a beveled surface 317 to, for example, lower resistance of fishing lure 300 moving through water. Beveled surface 317 may in turn adjoin bottom surface 324. In an embodiment, beveled surface 317 may form an angle with bottom surface 324, as illustrated. In an embodiment, beveled surface 317 may be curved to provide a smooth transition to bottom surface 324.

A balance weight 334 may be provided and suspended from bottom surface 324 on a screw eye 336. A sleeve 380 may optionally be mounted over a portion of the shaft of screw eye 336 to keep balance weight 334 a fixed distance from bottom surface 324. Alternatively, balance weight 334 may be allowed to move freely on the shaft of screw eye 336. An example of a sleeve is a piece of plastic tubing cut to the desired length.

Lure body 312 further comprises a near side surface 350, a far side surface 352, a near side intermediate portion 391 of near side surface 350, and a distal end surface 368. In an embodiment, the longitudinal axis of the fishing lure 300 may be substantially equidistant between near side surface 350 and far side surface 352 in middle region 353. Keel 326 comprises a near side surface 343. At least one fishing line attachment feature 330 is provided along near side surface 343 of keel 326.

The fishing lure 300 further comprises keels 326, 328, and 376 in the proximal end region 316. Keel 376 may be positioned in a slot 378 through lure body 312 extending substantially perpendicular between top surface 322 and bottom surface 324. Keel 376 may be held in the slot by press fit, adhesive, or fasteners. Alternatively, keel 376 may be formed unitary with lure body 312. Keels 326 and 338 may also be formed unitary with lure body 312. A fishhook attachment feature 342 may be provided at the distal end 318 of lure body 312. The fishhook attachment feature 342 may, for example, be an eye or a loop. A fishhook 346 may be connected to the fishhook attachment feature directly or indirectly, such as by a split ring 344.

FIG. 11 is a view along line C-C of FIG. 10, shown with the fishhooks and split rings removed from the fishing lure 300.

The fishing lure illustrated in FIGS. 9-11 is shown as comprising three keels. In an embodiment, a fishing lure may be constructed according to those FIGS., except that keels 326 and 328 are omitted.

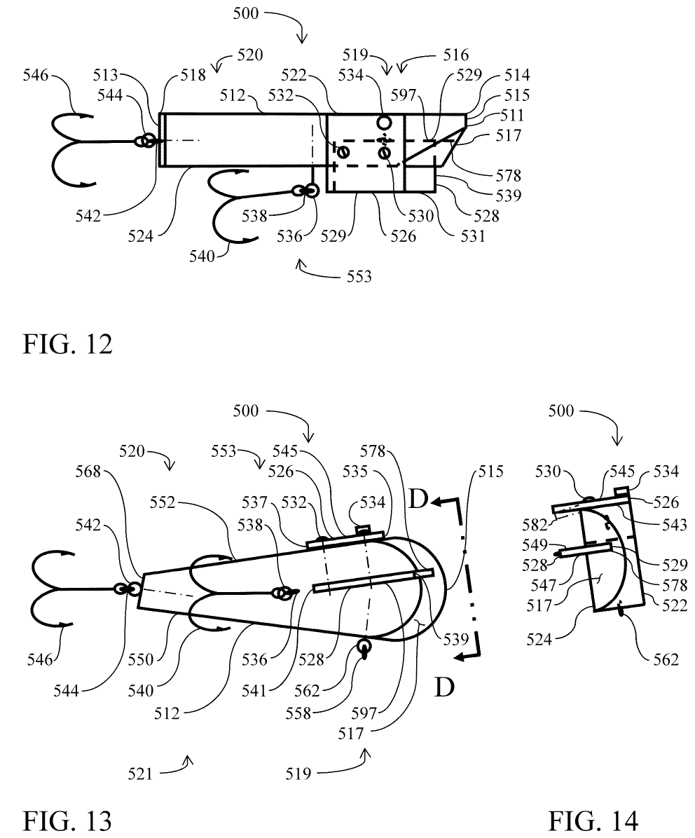

Referring now to FIGS. 12-14, illustrating an echeloning topwater fishing lure, the fishing lure 500 comprises a proximal end 511, a distal end 513, a proximal end region 519, a distal end region 521, and a lure body 512. Lure body 512 comprises a proximal end 514, a proximal end surface 515, a proximal end region 516, a distal end 518, a distal end region 520, a middle region 553, a top surface 522, a bottom surface 524, a slot 597, a longitudinal axis extending between proximal end 514 and distal end 518, and a vertical axis extending between top surface 522 and bottom surface 524. Lure body 512 may also comprise a beveled surface 517. Proximal end surface 515 may adjoin beveled surface 517 which in turn adjoins bottom surface 524. The transition from beveled surface 517 to bottom surface 524 may be at angle as illustrated or rounded. An example of material from which the lure body may be fabricated is cedar, though other wood, and/or other materials including plastic may be used alone or in conjunction with wood or other material(s).

The fishing lure 500 further comprises at least one keel 526 in the proximal end region 516. The fishing lure 500 may further comprise at least one additional keel 528, spaced apart from keel 526, in the proximal end region 516. Keel 526 comprises a bottom surface 529. Keel 528 comprises a bottom surface 531, a top surface 529, and a proximal end surface 539. The keels may be bent such that bottom keel surface 529 and bottom keel surface 531 are closer together than those keels are where they join the lure body. In embodiments in which the keels are made from, for example, aluminum flat bar, the corners and edges of the keels may be are rounded, for example with a metal file or grinder, so that, for example, fishing line to which the fishing lure is attached is less likely to get cut when it comes into contact with the corners and edges. Additional material may be removed from the corners to a create rounded corners pleasing to the fishing lure maker. If the keels are made by molding or 3D printing, the corners and edges may be formed rounded.

Keel 526 may be held on by fasteners 530 and 532, such as screws. Although fasteners are illustrated as holding on the keels, the keels may be glued on or the keels may be molded unitary the lure body, created by machining the lure body, be 3D printed unitary with the lure body, or otherwise constructed together with the lure body as one piece.

Fishhook attachment feature 536 may be, for example, an eye or a loop. A fishhook 540 may be connected to the fishhook attachment feature 536 directly or indirectly, such as by a split ring 538.

A fishhook attachment feature 542 may be provided at the distal end 518 of lure body 512. The fishhook attachment feature 542 may be, for example, an eye or a loop. A fishhook 546 may be connected to the fishhook attachment feature directly or indirectly, such as by a split ring 544.

Lure body 512 further comprises a near side surface 550, a far side surface 552, and a distal end surface 568. In an embodiment, the longitudinal axis of the fishing lure 500 may be substantially equidistant between near side surface 550 and far side surface 552 in middle region 553. Lure body 512 has a lateral axis extending between near side surface 550 and far side surface 552. The lateral axis of the lure body 512 is substantially perpendicular to the longitudinal axis of the fishing lure and substantially perpendicular to the vertical axis of the fishing lure. A slot 578 may be cut at a substantially right angle from the bottom surface 524 to, for example, halfway to top surface 522. In an embodiment, slot 578 may terminate at beveled surface 517, even though that in that configuration slot 578 may be longer along the longitudinal axis of the lure body than the length of keel 528.

In another embodiment, slot 578 is not formed halfway from bottom surface 524 to top surface 522, but rather is formed all the way through from surface bottom surface 524 to top surface 522. If making the lure body 512 out of wood, such a slot 578 may be made, for example, with a table saw. Keel 528 may be installed, for example, with its top surface 529 substantially flush with top surface 522 and with, for example, its proximal end surface 539 aligned to, and approximately flush with, proximal end surface 515.

Keel 528 is positioned in slot 578 and may be held in place by screwing fasteners 530 and 532 through it. Although fasteners are illustrated as holding keel 528 to the lure body 512, keel 528 may be attached with adhesive or the keel may be molded unitary with the lure body, created by machining the lure body, be 3D printed unitary with the lure body, or otherwise constructed together with the lure body as one piece.

Fishing line attachment feature 562 is provided along near side surface 550. The fishing line attachment feature 562 may be, for example, an eye or a loop, and optionally a split ring 558 may be attached to it. A fishing line may be connected to the fishing line attachment feature 562 directly or indirectly, such as by way of split ring 588.

Keel 526 comprises a far side surface 545, a proximal end surface 535, and a distal end surface 537. A balance weight 534 may be attached along far side keel 526 or along far side surface 545. An example of a balance weight is a lead disk with a clearance hole through it. Other balance weight locations are possible, such as on the top surface 522, on the bottom surface 524, or inside the lure body 512, resulting in fishing lure 500 floating with the far side surface 552 lower in elevation than the near side surface 550 floats when the fishing lure 500 is in a stationary floating position. The balance weight 534 may be a separate component or it may be integrated into the overall weight of keel 526.

Although the balance weight may be integrated into the overall weight of keel 526, one advantage of having balance weight 534 be a separate component is that it may be replaced with a heavier or a lighter weight to tune the fishing lure for differing predetermined trolling speeds. Another advantage is that the fishing lure may need less balance weight balance if fishhook 546 is replaced by a tail assembly.

FIG. 14 is a view along line D-D of FIG. 13, shown with the fishhooks and split rings removed from the fishing lure 500. Keel 526 further comprises a near side surface 543 and a far side surface 545. Keel 528 further comprises a near side surface 547, a distal end surface 541, and a far side surface 549. An example of an optional bend in keel 526 is illustrated by 582. Keel 528 may optionally be bent similarly to the bend illustrated by 582.

In operation, fishing lure 500 is placed on the surface of the water in a stationary position. The far side surface 552 of the lure body 512 floats lower in elevation in the water than the near side surface 550 floats. As the fishing lure 500 is accelerated, water resistance acting against near side surface 543 of keel 526 and near side surface 547 of keel 528 causes far side surface 522 to gradually rise upward. With the amount of balance weight 534 having been matched during assembly or by a user to a predetermined trolling speed, the fishing lure 500 travels along the surface of the water with the lateral axis of the lure body substantially perpendicular to the direction of gravity.

Optionally, the fishing lure 500 may be operated while trolled at a speed higher than the predetermined speed to which selection of the balance weight 534 was matched, resulting in a zigzagging, nearly sawtooth shaped, fishing lure path in operation. At such higher speed, far side surface 552 is oriented higher in elevation than near side surface 550. Far side surface 552 continues to climb and eventually reaches an elevation above the water's surface at which the sideways component of the tension in the fishing line connected to fishing lure 500 overcomes the keels' ability to fully steer the fishing lure 500 to a side. The fishing lure 500 briefly slides sideways while also continuing forward, moving closer to the course of the tip eye of the fishing rod to which the fishing lure is connected by fishing line. In this position, its side-to-side tilt approaches a non-tilted orientation and fishing lure 500 resumes its previous heading to a side of the fishing lure's course centerline away from the tip eye of the fishing rod.

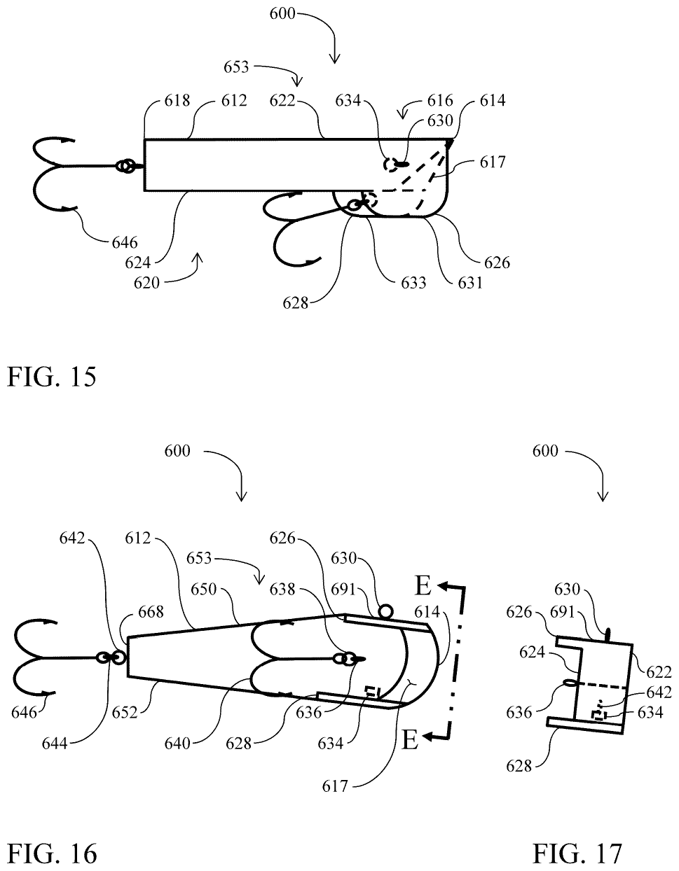

Referring now to FIGS. 15-17 illustrating an embodiment in which the keel(s) and lure body are formed together in one piece, a fishing lure 600 comprises a lure body 612. Lure body 612 comprises a proximal end 614, a proximal end region 616, a distal end 618, a distal end region 620, a middle region 653, a top surface 622, a bottom surface 624, a longitudinal axis extending between proximal end 614 and distal end 618, and a vertical axis extending between top surface 622 and bottom surface 624. Lure body 612 may also comprise a beveled surface 617. Beveled surface 617 may adjoin bottom surface 624 and may adjoin top surface 622 or adjoin a distal end surface 615. The transition from beveled surface 617 to bottom surface 624 may be at an angle as illustrated or rounded.

The fishing lure 600 further comprises at least one keel 626 in the proximal end region 616. The fishing lure 600 may further comprise at least one additional keel 628, spaced apart from keel 626, in the proximal end region 616. Keels 626 and 628 are formed together with lure body 612 in one piece. The corners of the keels 626 and 628 may be formed rounded. The radii of the rounding arcs may be very small or the radii may be considerably larger, such as to match the distance that a keel projects downward from the lure body 612. The keels 626 and 628 may be formed substantially planar or formed bent such that bottom keel surface 631 and keel bottom surface 633 are closer together than those keels are where they join the lure body 612. Alternatively, one of the keels may be formed bent and another may not be formed bent.

Lure body 612 further comprises a near side surface 650, a far side surface 652, a distal end surface 668, a near side intermediate portion 691 of near side surface 650, and a lateral axis extending between near side surface 650 and far side surface 652. In an embodiment, the longitudinal axis of the fishing lure 600 may be substantially equidistant between near side surface 650 and far side surface 652 in middle region 653. The lateral axis, longitudinal axis, and vertical axis of the fishing lure are substantially perpendicular to each other. A balance weight 634 may be provided at or near far side surface 652. An example of a balance weight is piece of metal in a shape suitable to the maker of the fishing lure. A fishing line attachment feature 630 is provided along near side surface 650 of the lure body 612 and may be, for example, an eye or a loop.

A fishhook attachment feature 636 may be provided on bottom surface 624. A fishhook 640 may be connected to fishhook attachment feature 636 directly or indirectly, such as by a split ring 638. A fishhook attachment feature 642 may be provided at the distal end 618 of lure body 612. The fishhook attachment feature 642 may be, for example, an eye or a loop. A fishhook 646 may be connected to the fishhook attachment feature 642 directly or indirectly, such as by a split ring 644.

FIG. 17 is a view along line E-E of FIG. 16, shown with the fishhooks and split rings removed from the fishing lure 600.

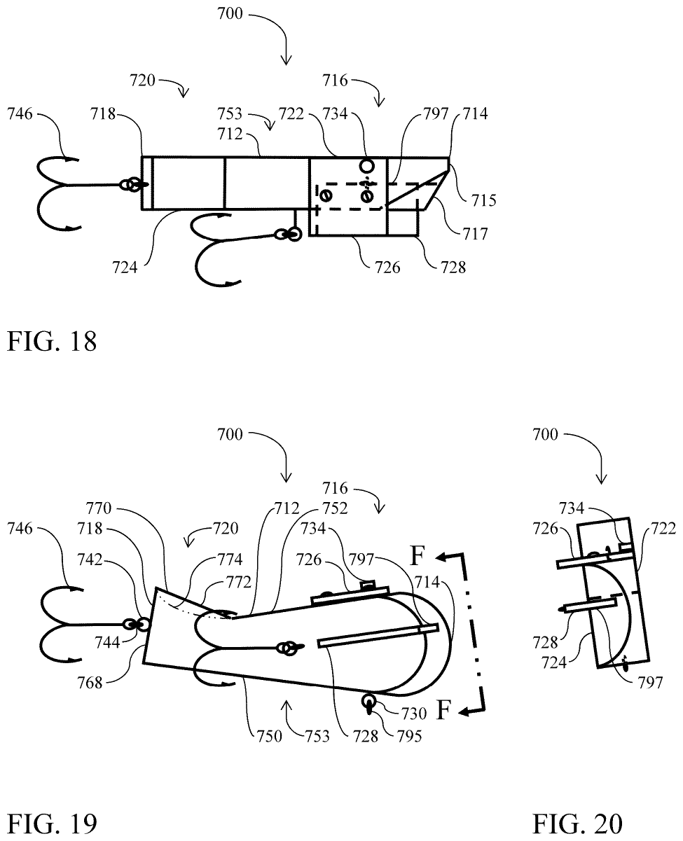

Referring now to FIGS. 18-20, a fishing lure 700 comprises a lure body 712. Lure body 712 comprises a proximal end 714, a proximal end region 716, a distal end 718, a distal end region 720, a middle region 753, a top surface 722, a bottom surface 724, a slot 797, a longitudinal axis extending between proximal end 714 and distal end 718, and a vertical axis extending between top surface 722 and bottom surface 724. Lure body 712 may also comprise a beveled surface 717. Proximal end surface 715 may adjoin a beveled surface 717, which in turn adjoins bottom surface 724. The transition between beveled surface 717 to bottom surface 724 may be at an angle as illustrated or rounded.

The fishing lure 700 further comprises at least one keel 726 in the proximal end region 716. The fishing lure may further comprise at least one additional keel 728, spaced apart from keel 726, in the proximal end region 716.

If desired, a cover member, such as cut from a sheet of plastic, may be applied to top surface 722 to present to a fish underneath the fishing lure 700 the silhouette of a prey animal, such as a bird, mammal, amphibian, reptile, fish, or other animal.

Lure body 712 further comprises a proximal end 714, a near side surface 750, a far side surface 752, and a distal end surface 768. In an embodiment, the longitudinal axis of the fishing lure 700 may be substantially equidistant between near side surface 750 and far side surface 752 in middle region 753. A balance weight 734 may be provided along far side surface 752. At least one fishing line attachment feature 730 is provided along near side surface 750 and may optionally have a split ring 795 attached to it. In distal end region 720, top surface 722, and bottom surface 724 flare toward the far side, creating secondary far side surface 770. Secondary far side surface 770 may be an angled surface 772 or may be a curved surface 774.

Proximal end surface 715 may adjoin a beveled surface 717, which in turn adjoins bottom surface 724. The transition between beveled surface 717 to bottom surface 724 may be at an angle as illustrated or round.

A fishhook attachment feature 742 may be provided at the distal end 718 of lure body 712. The fishhook attachment feature 742 may, for example, be an eye or a loop. A fishhook 746 may be connected to the fishhook attachment feature 742 directly or indirectly, such as by a split ring 744.

FIG. 20 is a view along line F-F of FIG. 19, shown with the fishhooks and split rings removed from the fishing lure 700.

In operation, the secondary far side surface is subjected to more resistance in the water than if it were not protruding out from far side surface 752. The force of the increased resistance causes the proximal end 714 to be turned further away from the fishing line to which the fishing lure is connected than if the secondary far side surface were not provided. This results in a greater echelon angle of the fishing lure in operation than a fishing lure without a secondary side surface.

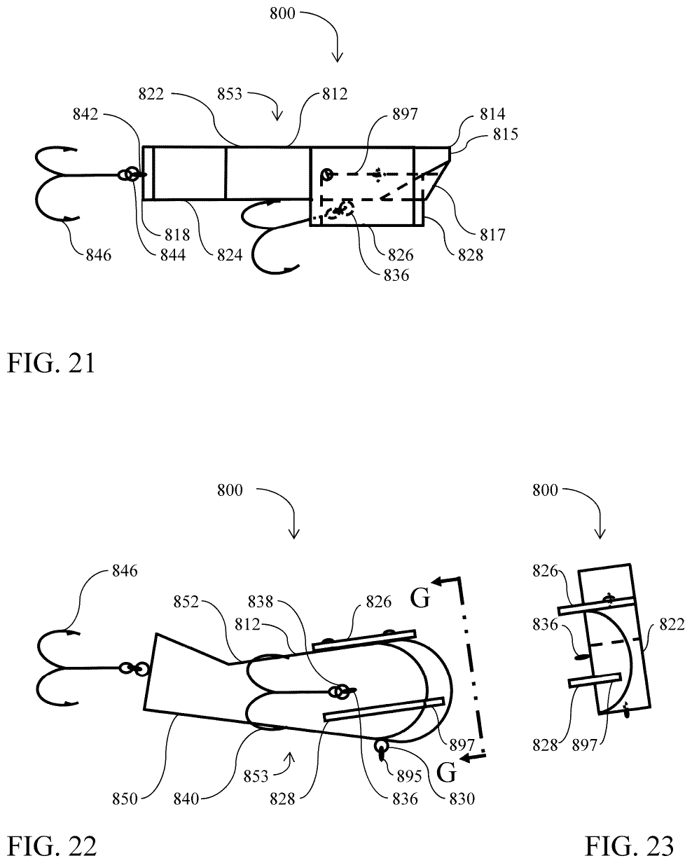

Referring now to FIGS. 21-23 illustrating a topwater fishing lure, fishing lure 800 comprises a lure body 812. Lure body 812 comprises a top surface 822, a bottom surface 824, a proximal end 814, a proximal end surface 815, a distal end 818, and a slot 897. Lure body 812 may also comprise a beveled surface 817. Proximal end surface 815 may adjoin a beveled surface 817, which in turn adjoins bottom surface 824. The transition between beveled surface 817 and bottom surface 824 may be angled as illustrated or rounded.

A fishhook attachment feature 842 may be provided at the distal end 818 of lure body 812. The fishhook attachment feature 842 may, for example, be an eye or a loop. A fishhook 846 may be connected to the fishhook attachment feature directly or indirectly, such as by a split ring 844.

Lure body 812 further comprises a near side surface 850 and a far side surface 852. The longitudinal axis of the fishing lure 800 may be substantially equidistant between near side surface 850 and far side surface 852 in middle region 853. At least one fishing line attachment feature 830 is provided along near side surface 850 and may optionally have a split ring 895 attached to it. Keel 826 may be provided on far side surface 852. Fishing lure 800 may comprise a second keel 828 spaced apart from keel 826 by a distance sufficient to allow placement of fishhook attachment feature 836 between keel 826 and keel 828 substantially equidistant between near side surface 850 and far side surface 852. Fishhook 840 may be connected to fishhook attachment feature 836 directly or indirectly, such as by a split ring 838.

FIG. 23 illustrates a view of FIG. 22 along line G-G, shown with the fishhooks and split rings removed.

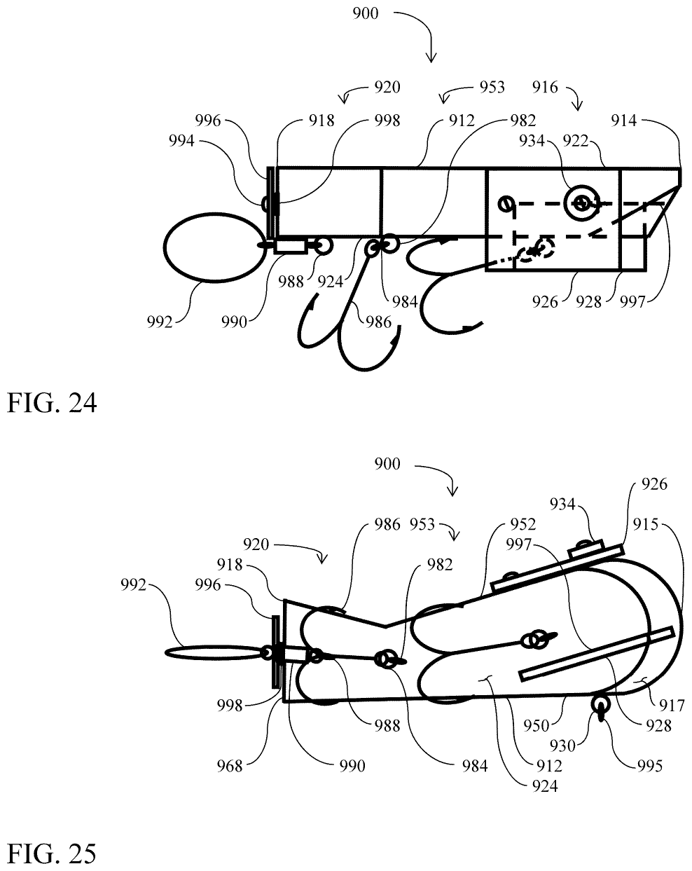

Referring now to FIGS. 24-25, a topwater surface fishing lure 900 comprises a lure body 912. Lure body 912 comprises a proximal end 914, a proximal end region 916, a distal end 918, a distal end region 920, a middle region 953, a top surface 922, a bottom surface 924, a slot 997, a longitudinal axis extending between proximal end 914 and distal end 918, and a vertical axis extending between top surface 922 and bottom surface 924. A swivel attachment feature 988 may be provided along bottom surface 924 in the distal end region 920.

The fishing lure 900 further comprises at least one keel 926 in the proximal end region 916. The fishing lure may further comprise at least one additional keel 928, spaced apart from keel 926, in the proximal end region 916.

Lure body 912 further comprises a proximal end surface 915, a near side surface 950, a far side surface 952, and a distal end surface 968. Proximal end surface 915 may adjoin a beveled surface 917, which in turn adjoins bottom surface 924. The transition between beveled surface 917 and bottom surface 924 may be at an angle as illustrated or rounded.

A balance weight 934 may be provided along far side surface 952. A fishing line attachment feature 930 is provided along near side surface 950. A split ring 995 may be optionally attached to fishing line attachment feature 930. A hook attachment feature 982 may be provided on bottom surface 924. A fishhook 986 may be connected to hook attachment feature 982 directly or indirectly, such as by split ring 984. A swivel attachment feature 988 may be provided on bottom surface 924. A swivel 990 may be attached to swivel attachment feature 988 at one end and a spinner blade 992 at its other end.

A fastener 994, such as a screw, may be provided on distal end surface 998 after sliding percussion plate 996 and spacer 998 over its shaft. An example of a suitable percussion plate 996 is a galvanized steel fender washer with an inner diameter slightly larger than the shaft diameter of fastener 994. An example of a suitable spacer is a galvanized steel flat washer with an inner diameter larger than the shaft diameter of fastener 994. In operation, spinner blade 992 flutters behind fishing lure 900 and occasionally strikes percussion plate 996, thus making a sound audible to fish.

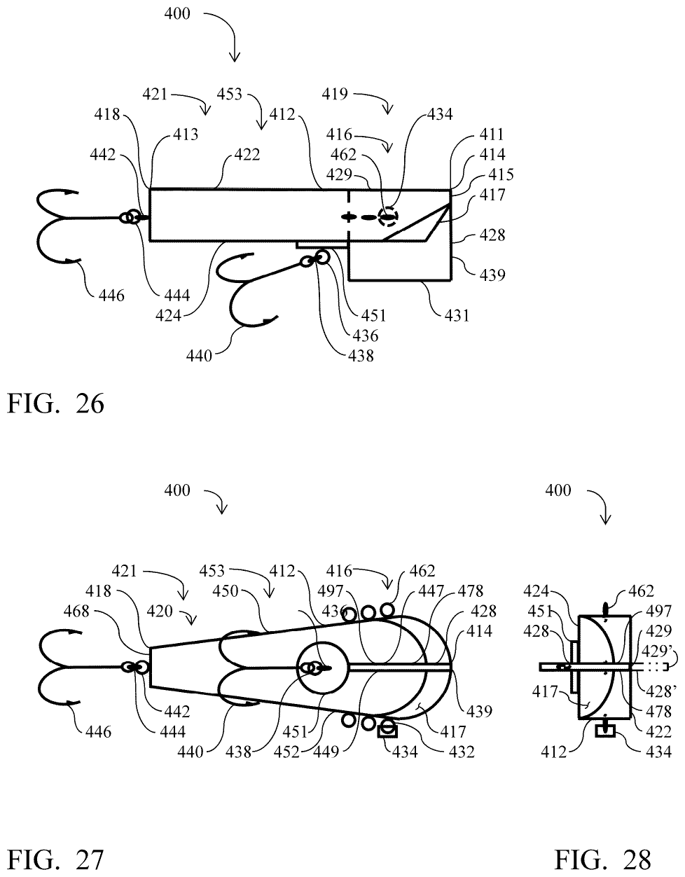

The fishing lure illustrated in FIGS. 26-28 is configured to be operable by a user as a port side echeloning fishing lure or a starboard side echeloning fishing lure, depending on the user's choice. In an embodiment in which the keel(s) and balance weight(s) are replaceable, the fishing lure may be converted by a user from a topwater fishing lure to a submersible fishing lure, and vice-versa. In an embodiment, the keel(s) may be replaced with taller or shorter keel(s) providing different echelon angles.

Fishing lure 400 comprises a proximal end 411, a distal end 413, a proximal end region 419, a distal end region 421, a through slot 497, a longitudinal axis extending between proximal end 411 and distal end 413, and further comprises a lure body 412. Lure body 412 comprises a proximal end 414, a proximal end surface 415, a proximal end region 416, a distal end 418, a distal end region 420, a middle region 453, a top surface 422, a bottom surface 424, a longitudinal axis extending between proximal end 414 and distal end 418, and a vertical axis extending between top surface 422 and bottom surface 424. Lure body 412 may also comprise a beveled surface 417. Proximal end surface 415 may adjoin a beveled surface 417, which in turn adjoins bottom surface 424. In another embodiment, at least a distal portion of the beveled surface may be curved to provide a smooth, rather than angular, transition into the bottom surface 424.

The fishing lure 400 further comprises at least one keel 428 in the proximal end region 416. In an embodiment, fishing lure 400 comprises more than one keel, spaced apart about the longitudinal axis of the lure body 412 from keel 428. Keel 428 comprises a bottom surface 431, a top surface 429, and a proximal end surface 439. In embodiments in which the keels are made from, for example, aluminum flat bar, the corners and edges of the keel(s) may be are rounded, for example with a metal file or grinder, so that fishing line to which the fishing lure is attached is less likely to get cut when it comes into contact with the corners and edges. Additional material may be removed from the corners to a create rounded corners pleasing to the fishing lure maker. In embodiments in which the keel is formed, for example, by molding or 3D printing, the corners and edges may be formed rounded.

Fishhook attachment feature 436 may be, for example, an eye or a loop. A fishhook 440 may be connected to the fishhook attachment feature 436 directly or indirectly, such as by a split ring 438.

A fishhook attachment feature 442 may be provided at the distal end 418 of lure body 412. The fishhook attachment feature 442 may be, for example, an eye or a loop. A fishhook 446 may be connected to the fishhook attachment feature 442 directly or indirectly, such as by a split ring 444.

Lure body 412 further comprises a first side surface 450, a second side surface 452, and a distal end surface 468. In an embodiment, the longitudinal axis of the fishing lure 400 may be substantially equidistant between first side surface 450 and second side surface 452 in middle region 453. Lure body 412 has a lateral axis extending between first side surface 450 and second side surface 452. The lateral axis of the lure body 412 is substantially perpendicular to the longitudinal axis of the fishing body and substantially perpendicular to the vertical axis of the lure body. Keel 428 comprises a first side surface 447 and a second side surface 449. A slot 478 may be formed, for example by cutting or molding, at a substantially right angle from the bottom surface 424 to the top surface 422. In an embodiment, the slot 478 may terminate at proximal end 414.

If making the lure body 412 out of, for example, wood, slot 478 may be made with a table saw. In an embodiment, keel 428 may be installed with its top surface 429, for example, substantially flush with top surface 422 and with its proximal end surface 439 for example, approximately flush with or extending beyond proximal end 414.

Keel 428 may be positioned in slot 478 and may be secured to the lure body by press fit or fasteners. If the fishing lure is to be configured only as a topwater lure, the keel may be secured by adhesive or the keel may be molded unitary with the lure body, may be created by machining the lure body, may be 3D printed unitary with the lure body, or may be otherwise constructed together with the lure body as one piece.

At least one fishing line attachment feature 462 is provided along first side surface 450. The fishing line attachment feature 462 may be, for example, an eye or a loop. A fishing line may be connected to the fishing line attachment feature 462 directly or indirectly, such as by way of a split ring and/or snap. More than one fishing line attachment feature 462 may be provided along first side surface 450 to create differing echelon angles during operation of the fishing lure. At least one fishing line attachment feature 432 is provided along second side surface 452. The fishing line attachment feature 432 may be, for example, an eye or a loop. A fishing line may be connected to the fishing line attachment feature 432 directly or indirectly, such as by way of a split ring. More than one fishing line attachment feature 432 may be provided along second side surface 452 to create differing echelon angles during operation of the fishing lure.

Labeling may be provided in proximity to the fishing line attachment features to indicate the average echelon angle the fishing lure is configured to create in operation when the fishing line is connected to a fishing line attachment feature. Illustrative examples are 10 degrees, 20 degrees, and 30 degrees or 15 degrees, 30 degrees, and 45 degrees.

If the fishing line is connected to fishing line attachment feature 462, then the first side surface 450 will be the near side surface in operation and the second side surface 452 will be the far side surface in operation. If the fishing line is connected to fishing line attachment feature 432, then the second side surface 452 will be the near side surface in operation and the first side surface 450 will be the far side surface in operation.

A first balance weight 434 may be provided on fishing line attachment feature 462 or 432. If the fishing line is to be attached to fishing line attachment feature 462, the first balance weight 434 may be installed on or near fishing line attachment feature 432. If the fishing line is to be attached to fishing line attachment feature 432, the first balance weight 434 may be installed on or near fishing line attachment feature 462. An example of a first balance weight is a lead bell sinker with a split ring attached to it.

A second balance weight 451 may be provided along bottom surface 420, for example, to configure the fishing lure to operate as a topwater fishing lure with increased stability or, for example, to configure the fishing lure to submerge in operation.

FIG. 28 is an end view of the fishing lure illustrated in FIGS. 26 and 27, shown with the fishhooks and split rings removed from the fishing lure 400. To convert the fishing lure 400 from an echeloning topwater fishing lure to an echeloning submersible fishing lure, keel 428 may be removed and replaced with a keel 428′ that may be taller along the vertical axis of the fishing lure 400 than keel 428. For example, keel top surface 429′ may extend above the top surface 422 of the lure body 412 and below the bottom surface 420 of the lure body 412 by substantially the same distance as the keel 428 that it replaces extends below the bottom surface 420 of the lure body 412. In an embodiment, first balance weight 434 may be removed. Second balance weight 451 may be replaced with a heavier second balance weight than was provided on the echeloning topwater fishing lure, so that the fishing lure 400 floats with proximal end 414 lower in elevation than distal end 418 and with proximal end 414 submerged.

In an embodiment, fishing lure 400 in its submersible fishing lure configuration may be converted to operate with greater side to side wander amplitude by replacing keel 428′ (having planar side surfaces 447 and 449) with a non-planar keel of similar dimensions. The portions of the side surface that extend away from the top surface 422 and bottom surface 420 of lure body 412 are twisted or otherwise formed at an angled with respect to the longitudinal axis of lure body 412.

In an embodiment, fishing lure 400 in its topwater fishing lure configuration may be converted to operate with greater side to side wander amplitude by replacing keel 428 (having planar side surfaces 447 and 449) with a non-planar keel of similar dimensions. The portions of the side surface that extend away from the top surface 422 and bottom surface 420 of lure body 412 are twisted or otherwise formed at an angled with respect to the longitudinal axis of lure body 412.

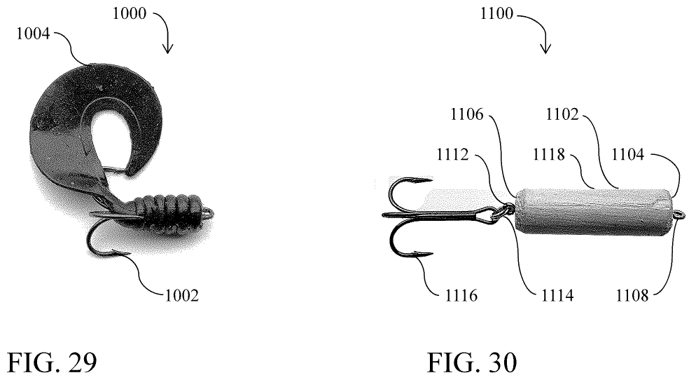

Tail assemblies such as those illustrated in FIGS. 29-32 may be installed on echeloning fishing lures embodying subject matter disclosed herein in place of any of fishhook 46, 146, 246, 346, 446, 546, 646, 746, 846, 2146, or 2246 shown in other FIGS.

Referring to FIG. 29, tail assembly 1000 comprises a fishhook 1002 with a flexible tail 1004 attached to it. Such flexible tails are often called grubs and are widely available from sporting goods stores. If a flexible tail is selected in a length similar to the length of the echeloning fishing lure to which it is to be connected, the echeloning lure may in operation mimic a swimming muskrat or other mammal. In an embodiment, the addition of tail assembly 1000 to an echeloning fishing lure adds action without adding substantial drag to the fishing lure, so the average echelon angle formed in operation of the combined fishing lure assembly (fishing lure plus tail assembly) may be the substantially the same as before tail assembly 1000 is added.

Referring to now FIG. 30, tail assembly 1100 comprises a generally cylindrical member 1102. Generally cylindrical member 1102 comprises a proximal end 1104, a distal end 1106, and a longitudinal axis extending between proximal end 1104 and distal end 1106. Generally cylindrical member 1102 may have a round or non-round cross section, and may optionally be chamfered at the proximal end 1104, at the distal end 1106, or at both ends. The generally cylindrical member 1102 may be tapered along its longitudinal axis. An attachment feature 1108, such as an eye or loop, is provided at proximal end 1104. A cross section of the cylindrical member 1102 in a mid-region 1118 may be, for example, circular, rectangular, or ovate. Cylindrical member 1102 may comprise a right cylinder or an oblique cylinder. A fishhook attachment feature 1112, such as an eye or a loop, may be provided at distal end 1106 of generally cylindrical member 1102. A fishhook 1116 may be attached to attachment feature 1112 directly or indirectly, such as by a split ring 1114.

Tail assembly 1100 may be constructed such that it is buoyant. A buoyant tail assembly may be attached to an echeloning submersible fishing lure to provide buoyancy to the distal end of the fishing lure.

In an embodiment, the addition of tail assembly 1100 to an echeloning fishing lure adds action without adding substantial drag to the fishing lure, so the average echelon angle formed in operation of the combined fishing lure assembly is similar to the average echelon angle in operation of the fishing lure without tail assembly 1100 added.

FIG. 31 illustrates a buzz blade type tail assembly. Tail assembly 1150 comprises a stiff wire 1152. An exemplary stiff wire is 0.051-inch diameter Model 4421-12-051 Looped End Wire Shaft available from LurePartsOnline.com. A distal loop 1154 may be formed in stiff wire 1152 by a lure maker if the stiff wire was not already provided with a loop from the supplier. A bead 1156 is slid onto the stiff wire 1152. An exemplary bead is a nickel-colored 3/16-inch Model 4521-03-004 Hollow Metal Bead available from LurePartsOnline.com. Two buzz blades 1158 and 1164 are installed on the stiff wire 1152, separated by two beads 1160 and 1162. For example, one Model 1407-05-021 Clockwise Prop Delta Blade and one Model 1407-07-021 Counterclockwise Prop Delta Blade available from LurePartsOnline.com may be used. More than two buzz blades and additional beads may be installed if desired. Bead 1168 is installed before proximal loop 1170 is formed by twisting the stiff wire 1152, such as by twisting the stiff wire 1152 with a pliers. Split ring 1172 is attached to distal loop 1154. Fishhook 1174 is attached to split ring 1172. Alternatively, a preformed loop in the stiff wire provided by the supplier may be used as the proximal loop, in which case, fishhook 1174 may be connected directly to distal loop 1152 without the need for a split ring 1172.

In an embodiment, the addition of tail assembly 1150 to an echeloning fishing lure adds both action and drag to the fishing lure. The increased drag decreases the average echelon angle formed in operation of the combined fishing lure assembly compared to the average echelon angle the same fishing lure forms in operation without tail assembly 1150 added. The degree of decrease of echelon angle depends on the size and/or number of buzz baits installed on the tail assembly. The larger in diameter the buzz blades provided are and/or the more buzz blades that are provided, the greater the resulting decrease in echelon angle will be.

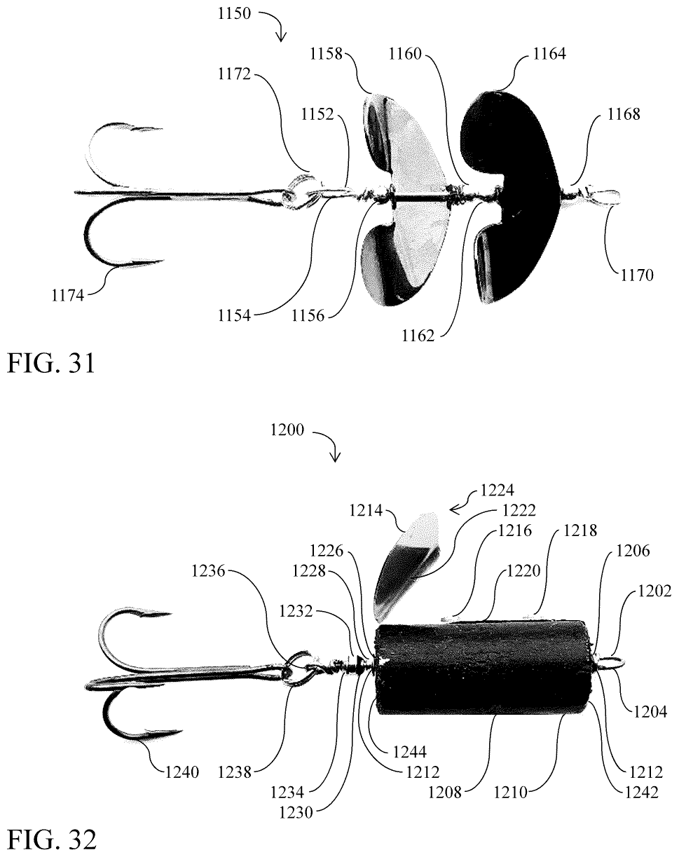

FIG. 32 illustrates a propeller type tail assembly. Tail assembly 1200 comprises a stiff wire 1202. An exemplary stiff wire is 0.051-inch diameter Model 4421-12-051 Looped End Wire Shaft available from LurePartsOnline.com. A proximal loop 1204 may be formed in stiff wire 1202 by a lure maker or may be pre-formed in the stiff wire provided by the supplier. A bushing 1206 is slid onto the stiff wire 1202. An exemplary bushing is a Model 1411-02 Turbo Buzz Blade Rivet available from LurePartsOnline.com. A propeller assembly 1208 is installed over the stiff wire 1202 and bushing 1206.

The propeller assembly 1208 comprises a buoyant cylindrical member 1210 with a proximal end surface 1242, a distal end surface 1244, and a longitudinal axis extending between proximal end surface 1242 and distal end surface 1244. A clearance hole 1212 is formed through the entire length of longitudinal axis. The clearance hole diameter is sized in accordance with the size of the bushings selected by the fishing lure maker. Blade 1214 is attached to buoyant cylindrical member 1210 by one or more screws 1216 and 1218. An exemplary blade is a model 4062 TallyWacker Tail available from lurepartsonlin.com. Preferably prior to assembly, blade 1214 is bend at a right angle along fold line 1220. Preferably prior to assembly, clearance holes are formed through blade 1214 to accommodate screws 1216 and 1218. Preferably prior to assembly, blade 1214 is bent at an angle along fold line 1222. The location of fold line 1222 and the degree of the angle formed about fold line 1222 is a matter of choice depending on how much drag is desired to be added to the fishing lure to which tail assembly 1200 is to be attached. The more blade material that is bent about fold line 1222, the more tail assembly 1200 will decrease the average echelon angle of the combined fishing lure assembly in operation as compared to the same fishing lure in operation without tail assembly 1200. The proximal end region 1224 of the blade 1214 may optionally be bent at a right angle, preferably before assembly, to descend along the proximal end surface 1242 of the buoyant cylindrical member 1210.

Bushing 1226 is slid onto the stiff wire 1202 and into the clearance hole 1212. Optional cup washer 1228 may be slid onto stiff wire 1202. An exemplary cup washer is a Model 4041-CW1 Cup Washer (0.225 inch outside diameter, 0.078 inch inside diameter) available from LurePartsOnline.com. An optional cup washer 1230 may be slid onto stiff wire 1202. Bead 1232 is slid onto stiff wire 1202. An optional cup washer 1234 is slid onto stiff wire 1202. A fishhook 1240 may be provided and attached directly to stiff wire 1202 before a distal loop 1236 is formed or it may be attached after distal loop 1236 is formed, by using a split ring 1238 to attach it. Distal end loop 1236 is formed in stiff wire 1202 by bending, such as my twisting the stiff wire 1202 with a pliers. It is to be understood that if stiff wire with a preformed loop is provided by the supplier of the stiff wire, a lure make may prefer to use the preformed loop as be distal loop 1236 instead of proximal loop 1204 and assemble tail assembly 1200 in reverse order.

In an embodiment, the addition of tail assembly 1200 to an echeloning fishing lure adds action and drag to the fishing lure. The increased drag decreases the average echelon angle formed in operation of the combined fishing lure assembly compared to the average echelon angle the same fishing lure forms in operation without tail assembly 1200 added. The decreased echelon angle enables operation of an echeloning fishing lure with tail assembly 1200 added to it to operate beside a substantially identical echeloning fishing lure without a tail assembly 1200 added to it. For example, a conventional fishing lure can be operated directly behind the tip eye of a fishing rod to which the conventional fishing lure is attached by fishing line, an echeloning fishing lure without tail assembly 1200 attached to it can be operated well to a side of the conventional fishing lure, and an echeloning fishing lure with tail assembly 1200 attached to it can be operated in between the other two fishing lures.

In an embodiment, a propellor tail assembly removed from a commercially available fishing lure may be used in place of for tail assembly 1200. For example, the propellor tail assembly may be removed from a Gooch's TallyWacker lure, available from Thorne Bro. Custom Rod and Tackle located at 10091 Central Ave NE, Blaine, MN 55434.

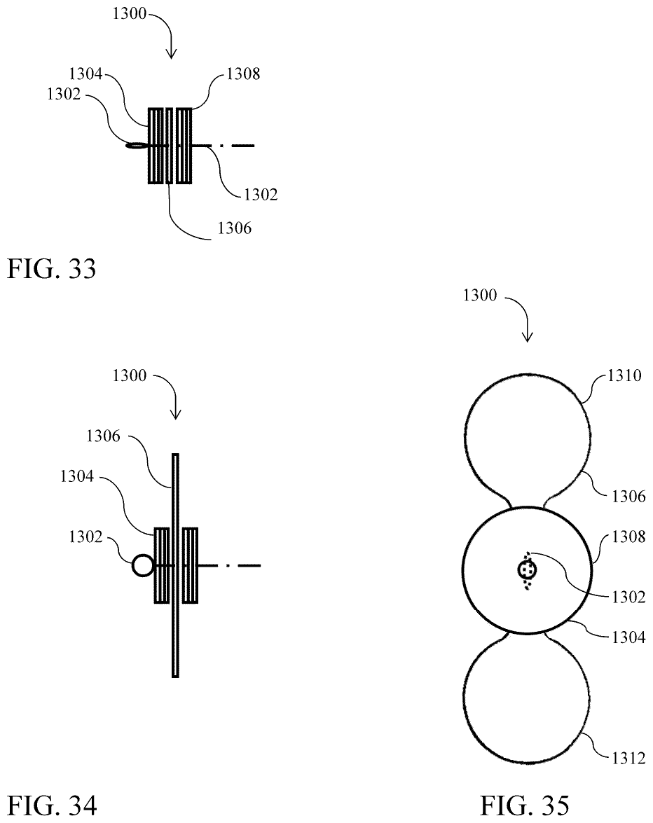

Referring to FIG. 33 illustrating a top view of another propeller-type tail assembly, tail assembly 1300 may be installed in place of fishhook 46, 146, 246, 346, 446, 546, 646, 746, or 846, 2146, or 2246 shown in other FIGS. and the fishhook attachment feature to which the fishhook is attached. If a split ring was used to attach the fishhook to the fishhook attachment feature, the split ring is also removed.

Tail assembly 1300 comprises a screw eye 1302. One or more washers 1304 are installed over the shaft of screw eye 1302. Next, propeller 1306 is installed over the shaft of screw eye 1302. An exemplary propeller is a model 4033 Monster Prop from LurePartsOnline.com. Next, one or more additional washers 1308 are installed over the shaft of screw eye 1302.

FIG. 34 illustrates a side view of the tail assembly illustrated in FIG. 33.

FIG. 35 illustrates an enlarged end view of the tail assembly illustrated in FIGS. 33 and 34. Propeller lobes 1310 and 1312 may be bent or twisted before or after assembly of tail assembly 1300 to provide a suitable fishing lure action, for example, twisted and/or bent as illustrated in the aforementioned patent to Henkenius. In operation, the tail assembly 1300 adds action to an echeloning fishing lure and also increases the drag on an echeloning fishing lure.

In an embodiment, the increased drag decreases the average echelon angle formed in operation of the combined fishing lure assembly compared to the average echelon angle the same fishing lure forms in operation without tail assembly 1300 added. The decreased echelon angle enables operation of an echeloning fishing lure with tail assembly 1300 added to it to operate beside a substantially identical echeloning fishing lure without tail assembly 1300 added to it. Propeller lobes 1310 and 1312 can be bent by a user to increase or decrease drag to produce a different echelon angle in operation. Two substantially identical fishing lures with substantially identical tail assemblies 1300, except that lobes 1310 and 1312 of one tail assembly 1300 are bent more than lobes 1310 and 1312 of the other tail assembly 1300, may be operated beside each other. Those two combined fishing lure assemblies may be operated between a substantially identical fishing lure that does not have a tail assembly 1300 assembled onto it and a conventional fishing lure, resulting in four fishing lures operating side by side.

A kit containing tail assemblies such as 1000, 1100, 1150, 1200, 1300, and/or other tail assemblies corresponding to echeloning fishing lure models may be provided for a user to assemble onto the user's echeloning fishing lure to change its operating characteristics to one more suitable to the user for a particular fishing condition. In an embodiment, if drag in operation is increased by the addition of a tail assembly, then less balance weight may be desired for a selected operating speed. Balance weights of varying heaviness may be provided in the kit. Included in the kit, or provided separately, balance weights of differing heaviness may be provided for configuring the fishing lure for differing operating speeds.

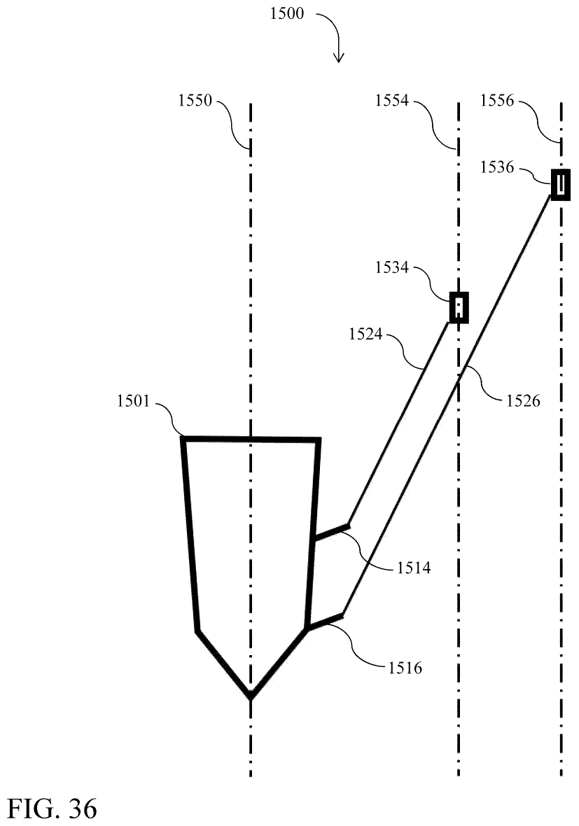

FIGS. 36-40 illustrate methods of operating echeloning fishing lures. It is typical in angler vocabulary to call both a “fishing lure” and a “combined fishing lure assembly” simply a “fishing lure”. The usage and scope of the term “fishing lure” in reference to the methods illustrated in FIGS. 36-40 include both a fishing lure and combined fishing lure assembly without distinction between them.

Referring to now FIG. 36 illustrating a schematic plan view of a method 1500 of operating echeloning fishing lures, a boat 1501 is following a boat course centerline 1550. Fishing rods 1514 and 1516 are connected to boat 1501. Fishing lure 1534 is an echeloning fishing lure, topwater or submersible, configured to create an echelon angle of, for example, 20 degrees. It is to be understood that fishing rods comprise a tip eye at their distal end (the end opposite the butt end of the fishing rod) through which the fishing line passes. The fishing line connected to an echeloning fishing lure forms an echelon angle with the course of the tip eye of the fishing rod. Fishing lure 1536 is also an echeloning fishing lure, topwater or submersible, configured to create an echelon angle of the same number of degrees as fishing lure 1534 is configured to create. Fishing line 1524 is connected to fishing lure 1534 on one end and fishing rod 1514 on the other end. Fishing line 1526 is connected to fishing lure 1536 on one end and fishing rod 1516 on the other end.

In operation, fishing lure 1534 follows lure course centerline 1554 and fishing lure 1536 follows lure course centerline 1556. Both lure course centerlines 1554 and 1556 are parallel to boat course centerline 1550 when boat 1501 is traveling along a straight line.

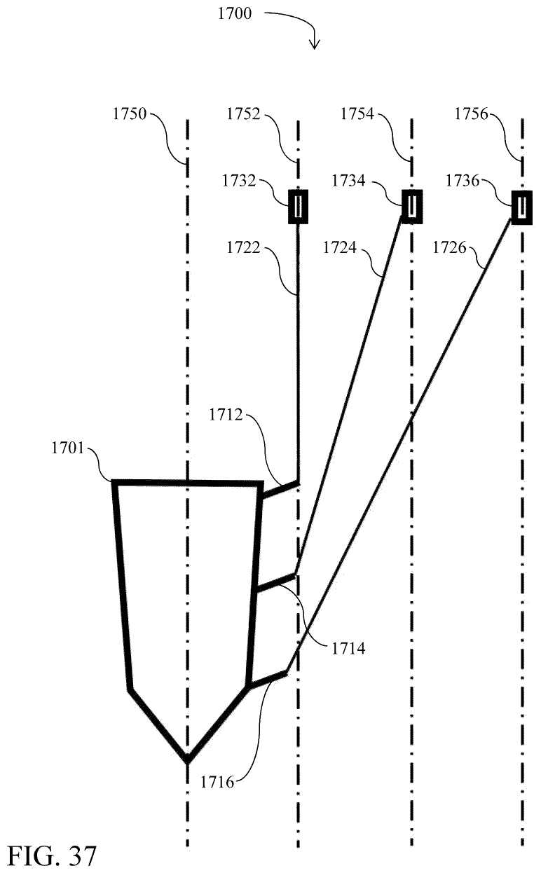

Referring to now FIG. 37 illustrating a schematic plan view of a method 1700 of operating topwater fishing lures, a boat 1701 is following a boat course centerline 1750. Fishing rods 1712, 1714, and 1716 are connected to boat 1701. Fishing lure 1732 is a conventional fishing topwater fishing lure. Fishing lure 1734 is an echeloning topwater fishing lure, configured to create of an echelon angle of, for example, 10 degrees. Fishing lure 1736 is also an echeloning topwater fishing lure, configured to create an echelon angle of, for example, twice the number of degrees that fishing lure 1734 is configured to create. Fishing line 1722 is connected to fishing lure 1732 on one end and fishing rod 1712 on the other end. Fishing line 1724 is connected to fishing lure 1734 on one end and fishing rod 1714 on the other end. Fishing line 1726 is connected to fishing lure 1736 on one end and fishing rod 1716 on the other end.

In operation, fishing lure 1732 follows fishing lure course centerline 1752. Fishing lure 1734 follows lure course centerline 1754. Fishing lure 1736 follows lure course centerline 1756. All three fishing lure course centerlines 1752, 1754, and 1756 are parallel to boat course centerline 1750 when boat 1701 is traveling along a straight line.

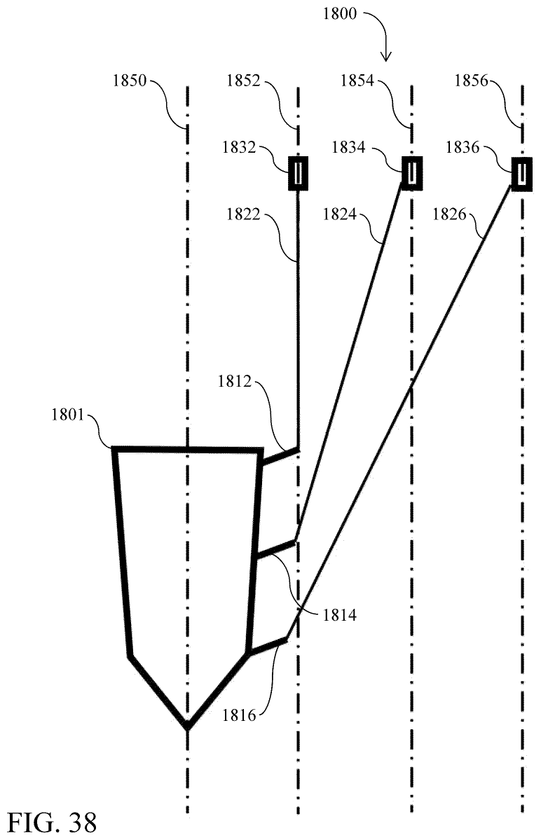

Referring to now FIG. 38 illustrating a schematic plan view of a method 1800 of operating submersible fishing lures, a boat 1801 is following a boat course centerline 1850. Fishing rods 1812, 1814, and 1816 are connected to boat 1801. Fishing lure 1832 is a conventional submersible fishing lure. Fishing lure 1834 is an echeloning submersible fishing lure, configured to create an echelon angle of, for example, 10 degrees. Fishing lure 1836 is also an echeloning submersible fishing lure, configured to create an echelon angle of, or example, twice the number of degrees that fishing lure 1834 is configured to create. Fishing line 1822 is connected to fishing lure 1832 on one end and fishing rod 1812 on the other end. Fishing line 1824 is connected to fishing lure 1834 on one end and fishing rod 1814 on the other end. Fishing line 1826 is connected to fishing lure 1836 on one end and fishing rod 1816 on the other end.

In operation, fishing lure 1832 follows fishing lure course centerline 1852. Fishing lure 1834 follows lure course centerline 1854. Fishing lure 1836 follows lure course centerline 1856. All three fishing lure course centerlines 1852, 1854, and 1856 are parallel to boat course centerline 1850 when fishing boat 1801 is traveling along a straight line.

It is also to be understood that multiple echeloning submersible fishing lures and multiple echeloning topwater fishing may be simultaneously operated off a single gunnel, for example with the rods connected to the echeloning topwater lures being positioned closer to the bow the boat than the rods connected to the echeloning submersible fishing lures. In this way, the method illustrated in FIG. 37 and the method illustrated in FIG. 38, and variations thereof, may be practiced simultaneously allowing the user to operate six fishing lures from a gunnel.

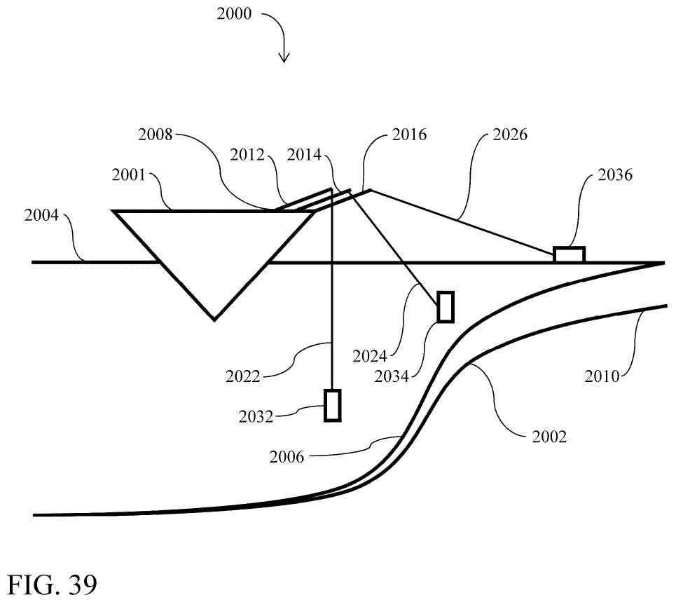

Referring to FIG. 39 in which a schematic front view of a method 2000 of operating fishing lures is illustrated, boat 2001 (illustrated as coming toward a viewer) is traveling above a selected depth of bottom contour 2002 of a water body 2004 that has submerged plants extending up from bottom contour 2002 to submerged plant growth upper limit 2006. Boat 2001 comprises a gunnel 2008 facing the shallow side 2010 of the bottom contour 2002. Boat 2001 has three rods 2012, 2014, and 2016 mounted on gunnel 2008 and connected, respectively, to fishing lines 2022, 2024, and 2026. Fishing lines 2022, 2024, and 2026 are connected, respectively, to conventional submersible fishing lure 2032, echeloning submersible fishing lure 2034, and echeloning topwater fishing lure 2036. As the boat 2001 is used to troll above and along a constant depth of the bottom contour 2002, each of the fishing lures 2032, 2034, and 2036 stays above submerged plant upper limit 2006.

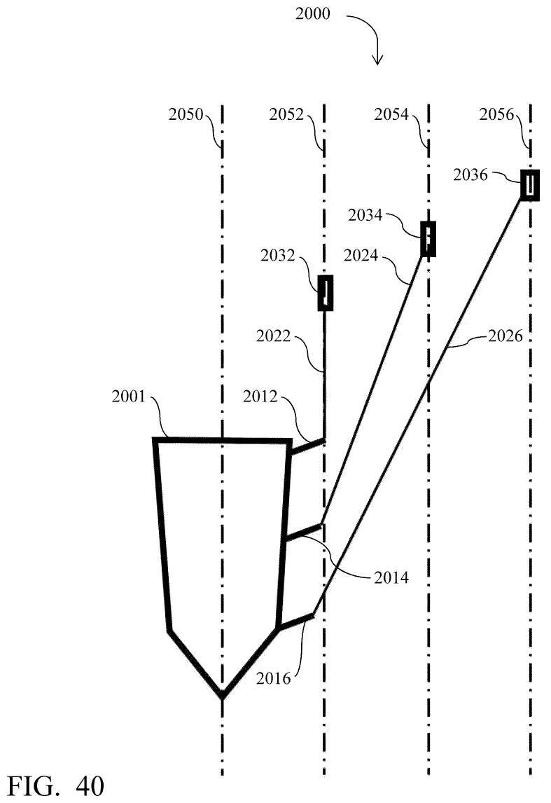

FIG. 40 is a schematic plan view of the method 2000 of operating fishing lures illustrated in FIG. 39. Boat 2001 is moving along boat course centerline 2050. Conventional submersible fishing lure 2032 is operating along fishing lure course centerline 2052. Echeloning submersible fishing lure 2034 is operating along fishing lure course centerline 2054. Echeloning topwater fishing lure 2036 is operating along fishing lure course centerline 2056. Fishing lure course centerlines 2052, 2054, and 2056 are parallel to boat course centerline 2050 when boat 2001 is traveling along a straight line.

Although fishing rod locations are illustrated in FIGS. 37-40 as spaced out along the side of the gunnel of the boat, they can optionally be mounted very close together and the tip eyes of the fishing rods can even be touching each other in operation without risk that a fishing lure connected to one fishing line may become entangled on a fishing line connected to another fishing lure.

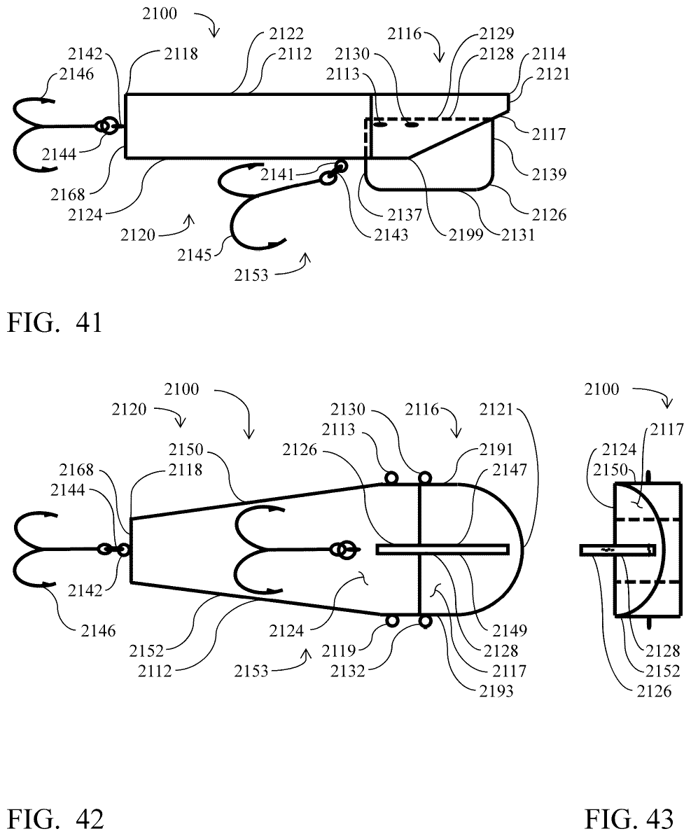

The echeloning topwater fishing lure illustrated in FIGS. 41-43 is configured so as to be operable from a port side of a boat or from a starboard side of a boat, depending on the user's preference. The either-handed design of the fishing lure is also useful for anglers desiring to use the fishing lure from either bank of a stream.

Referring further to FIGS. 41-43, fishing lure 2100 comprises a lure body 2112. Lure body 2112 comprises a top surface 2122, a bottom surface 2124, a proximal end 2114, a proximal end surface 2121, a proximal end region 2116, a middle region 2153, a distal end 2118, a distal end surface 2168, a distal end region 2120, a longitudinal axis extending between proximal end 2114 and distal end 2118, and a vertical axis extending between top surface 2122 and bottom surface 2124.

In an embodiment, proximal end surface 2121 may adjoin a beveled surface 2117. Beveled surface 2117 may in turn adjoin bottom surface 2124. Beveled surface 2117 may, for example, enable fishing lure 2100 to more readily negotiate waves that the fishing lure may encounter along its course. In an embodiment, beveled surface 2117 may be flat as illustrated, extending from proximal end surface 2121 to transition line 2199 where it adjoins bottom surface 2124. In an embodiment, at least a distal portion of the beveled surface may be curved to provide a smooth, rather than angular, transition into the bottom surface 2124.

The fishing lure 2100 further comprises at least one keel 2126 in the proximal end region 2116. Keel 2126 comprises of a top surface 2129, a bottom surface 2131, a proximal end surface 2139, a distal end surface 2137, a first side surface 2147, and a second side surface 2149. A longitudinal axis of keel 2126 extends between proximal end surface 2139 of the keel 2126 and the distal end surface 2137 of the keel 2126. The longitudinal axis of the keel may be substantially parallel the longitudinal axis of the lure body 2112. In an embodiment, the longitudinal axis of the keel coincides with the longitudinal axis of the lure body.

A fishhook attachment feature 2141 may be provided along bottom surface 2124 in the middle region 2153 of lure body 2112. The fishhook attachment feature 2141 may, for example, be an eye or a loop. A fishhook 2145 may be connected to the fishhook attachment feature directly or indirectly, such as by a split ring 2143. A fishhook attachment feature 2142 may be provided along the distal end surface 2168 of lure body 2112. The fishhook attachment feature 2142 may, for example, be an eye or a loop. A fishhook 2146 may be connected to the fishhook attachment feature directly or indirectly, such as by a split ring 2144.

Lure body 2112 further comprises a first side surface 2150, a first side intermediate portion 2191 of first side surface 2150, a second side surface 2152, and a second side intermediate portion 2193 of second side surface 2152. In an embodiment, the longitudinal axis of the fishing lure 2100 may be substantially equidistant between first side surface 2150 and second side surface 2152 in middle region 2153. As illustrated, the bottom surface 2124 meets the first side surface 2150 at a corner, the first side surface 2150 meets the top surface 2122 at a corner, the top surface 2122 meets the second side surface 2152 at a corner, and the second side surface 2152 meets the bottom surface 2124 at a corner. It is to be understood that the corners may be formed rounded or beveled without departing from the spirit and scope of the fishing lures disclosed herein. In an embodiment, the rounding may produce a lure body having a round or elliptical cross-section in at least a portion of the lure body. In an embodiment, the beveling may produce fishing lures with a substantially non-rectangular polygonal cross-section in at least a portion of the lure body.

Slot 2128 is formed through at least a portion of lure body 2112 in proximal end region 2116. In an embodiment in which fishing lure 2100 comprises a beveled surface 2117, slot 2128 may continue through a portion of the bottom surface 2124. Slot 2128 is provided to fittingly mount keel 2126 in proximal end region 2116. Slot 2128 is shaped and sized to mate with that portion of keel 2126 inserted thereto. Keel 2126 is positioned in slot 2128 and may be secured to lure body 2112 by press fit, mechanical fasteners, adhesive bonding, or other affixation methods.

At least one fishing line attachment feature 2113 is provided along first side intermediate portion 2191. An additional fishing line attachment feature 2130 may optionally be provided on first side intermediate portion 2191. At least one fishing line attachment feature 2119 is provided along second side intermediate portion 2193. An additional fishing line attachment feature 2132 may be provided on second side intermediate portion 2193. An additional fishing line attachment feature may optionally be provided on the proximal end surface 2121, so that the fishing lure may be optionally operated in a conventional, non-echeloning position.

In an embodiment, first side surface 2150 and second side surface 2152 extend proximally to proximal end surface 2121 and first side intermediate portion 2191 and second side intermediate portion 2193 are not present in the embodiment.

FIG. 43 is an end view of the fishing lure illustrated in FIGS. 41 and 42, shown with the fishhooks and split rings removed from the fishing lure 2100.

Although the fishing lure 2100 illustrated in FIGS. 41-43 is illustrated as assembled from numerous components, it is to be understood that the keel may be molded unitary with the lure body, may be created by machining, may be 3D printed unitary with the lure body, or may be otherwise constructed together with the lure body as one piece.

Although keel 2126 is illustrated as lying along the longitudinal axis of the lure body 2112, it is to be understood that two keels may be provided, one on either side of the longitudinal axis. It is also to be understood that more than two keels may be provided; for example, one along the longitudinal axis of the lure body and the others spaced apart on either side of that axis. It is to be understood as well that a fishing lure may be made with its keel(s) offset to a side of the longitudinal axis, so that, for example, the fishing lure produces a greater echelon angle when fishing line is connected to a fishing line connection feature on one side of the lure body than when fishing line is connected to the opposing fishing line connection feature on the other side of the lure body.

In operation of the embodiment illustrated in FIGS. 41-43, fishing lure 2100 is connected to a fishing line which in turn is connected to a fishing rod that is connected to a boat moving along a straight course. The fishing rod comprises a tip eye at its distal end (the end opposite the butt end of the rod). While the fishing line is connected to fishing line attachment feature 2113 or to second fishing line attachment feature 2119, a maximum average echeloning angle is created by the fishing lure 2100. While the fishing line is connected to fishing line attachment feature 2130 or to fishing line attachment feature 2132, a lesser echelon angle is created by the fishing lure. It is to be understood that although two fishing line attachment features are illustrated on each of the first intermediate side portion and second intermediate side portion of the lure body, a single fishing line attachment feature may, for example, be provided along the first intermediate side portion and another fishing line attachment feature along the second intermediate side portion to produce a lure with a single echelon angle setting. It is also to be understood that more than two fishing line attachment features may be provided along a side surface and/or intermediate side portion to produce a lure with more echelon angle settings.

In an embodiment, a balance weight may be added opposite the fishing line connection feature to which the fishing line is connected, for example, to tune the fishing lure to operate at a particular speed. An example of a balance weight is a lead bell sinker held on by a split ring or snap, though other weights and weight attachment devices may be used.

In operation, fishing lure 2100 may be placed on the surface of the water in a stationary position directly behind the tip eye of a fishing rod connected to a stationary boat. As the boat begins moving forward and continues to move forward in a straight line on a calm water surface, echeloning topwater fishing lure 2100, connected to create an echelon angle of, for example, 30 degrees, tracks out to a side until it achieves its pre-selected echelon angle setting and thereafter will proceed in a substantially straight line along a course centerline parallel to the course centerline of the tip eye. If the boat rocks side-to-side, some sinusoidal path deviation may be induced into the fishing lure's course.

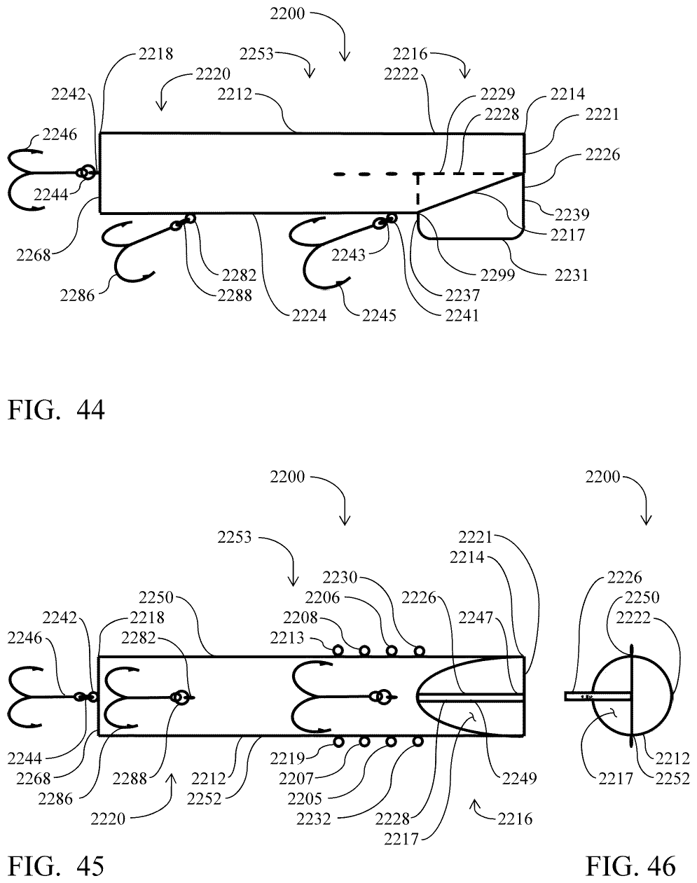

The echeloning zigzagging topwater fishing lure illustrated in FIGS. 44-46 is configured so as to be operable by a user from a port side of a boat or from a starboard side of a boat, depending on the user's preference. The either-handed design of the fishing lure is also useful for anglers desiring to use the fishing lure from either bank of a stream. Zigzagging fishing lure action is often referred to colloquially by anglers as “walking the dog” and a fishing lure that produces such action is colloquial referred to as a “walk the dog” fishing lure.

Referring further to FIGS. 44-46, fishing lure 2200 comprises a partially truncated cylindrical lure body 2212. Lure body 2122 comprises a top surface 2222, a bottom surface 2224 opposed to top surface 2222, a first side surface 2250 extending between top surface 2222 and bottom surface 2224, a second side surface 2252 mirroring and opposed to first side surface 2250, a proximal end 2214, a proximal end surface 2221, a proximal end region 2216, a middle region 2253, a distal end 2218, a distal end surface 2268, a distal end region 2220, a longitudinal axis extending between proximal end 2214 and distal end 2218, and a vertical axis extending between top surface 2222 and bottom surface 2224. In an embodiment, the longitudinal axis of the fishing lure 2200 may be substantially equidistant between first side surface 2250 and second side surface 2252 in middle region 2253 and substantially equidistant between top surface 2222 and bottom surface 2224 in middle region 2253.

In an embodiment, proximal end surface 2221 may adjoin a beveled surface 2217. Beveled surface 2217 may in turn adjoin bottom surface 2224. In an embodiment, beveled surface 2217 enables fishing lure 2200 to more readily negotiate waves that the fishing lure may encounter along its course. In an embodiment, beveled surface 2217 may be flat as illustrated, extending from proximal end surface 2221 to transition zone 2299 with the bottom surface 2224. In another embodiment, at least a distal portion of the beveled surface may be curved to provide a smooth, rather than angular, transition into the bottom surface 2224.

The fishing lure 2200 further comprises at least one keel 2226 in the proximal end region 2216. Keel 2226 comprises of a top surface 2229, bottom surface 2231, a proximal end surface 2239, distal end surface 2237, a first side surface 2247, and a second side surface 2249. A longitudinal axis of keel 2226 extends between proximal end surface 2239 of the keel 2226 and the distal end surface 2237 of the keel 2226. The longitudinal axis of the keel may be substantially parallel the longitudinal axis of the lure body 2212.

A fishhook attachment feature 2241 may be provided along the bottom surface 2224 in the middle region 2253 of lure body 2212. The fishhook attachment feature 2241 may, for example, be an eye or a loop. A fishhook 2245 may be connected to the fishhook attachment feature directly or indirectly, such as by a split ring 2243. A fishhook attachment feature 2242 may be provided at the distal end surface 2268 of lure body 2212. The fishhook attachment feature 2242 may, for example, be an eye or a loop. A fishhook 2246 may be connected to the fishhook attachment feature directly or indirectly, such as by a split ring 2244.

Slot 2228 is formed through at least a portion of lure body 2212 in proximal end region 2216. In an embodiment in which fishing lure 2200 comprises a beveled surface 2217, slot 2228 may continue through a portion of the bottom surface 2224. Slot 2228 is provided to fittingly mount keel 2226 in proximal end region 2216. Slot 2228 is shaped and sized to mate with the portion of keel 2226 inserted thereto. Keel 2226 is positioned in slot 2228 and may be secured to lure body 2212 by press fit, mechanical fasteners, adhesive bonding, or other affixation methods.

At least one fishing line attachment feature 2213 is provided along first side surface 2250. Additional fishing line attachment features 2230, 2206, and/or 2208 may optionally be provided on first side surface 2250. At least one fishing line attachment feature 2219 is provided along second side surface 2252. Additional fishing line attachment features 2232, 2205, and/or 2207 may be provided on second side surface 2252. An additional fishing line attachment feature may optionally be provided on the proximal end surface 2221, so that the fishing lure may be operated in a conventional, non-echeloning position. A fishhook attachment feature 2282 may be provided on bottom surface 2224 in the distal region 2220. A fishhook 2286 may be connected to hook attachment feature 2282 directly or indirectly, such as by split ring 2288.

Referring to FIG. 46 illustrating an end view of the fishing lure illustrated in FIGS. 44-45, shown with the fishhooks and split rings removed from the fishing lure 2200, the fishing lure as illustrated comprises a lure body having a circular cross-section in at least the middle region 2253.

In operation of the embodiment illustrated in FIGS. 44-46, fishing lure 2200 is connected to a fishing line which in turn is connected to a fishing rod that is connected to a boat moving along a straight course. The fishing rod comprises a tip eye at its distal end (the end opposite the butt end of the rod). While the fishing line is connected to the first side surface 2250 distal most fishing line attachment feature 2213 or second side surface 2252 distal most fishing line attachment feature 2219, the maximum average echeloning angle and maximum average “walk the dog” amplitude results. While the fishing line is connected to the first side surface 2250 second most distal fishing line attachment feature 2208 or second side surface 2252 second most distal fishing line attachment feature 2207, less echeloning angle and “walk the dog” result than if connected to first side surface 2250 distal most fishing line attachment feature 2213 or second side surface 2252 distal most fishing line attachment feature 2219. When the fishing line is connected to even more proximal fishing line connection features, the resulting echelon angle and “walk the dog” action amplitude continue to decrease. While the fishing line is connected to the first side surface 2250 proximal most fishing line attachment feature 2230 or the second side surface 2252 proximal most fishing line attachment feature 2232, the least amount of echelon angle and least “walk the dog” amplitude result. It is to be understood that although four fishing line attachment features are illustrated on each of the first side and second side of the lure body, a single fishing line attachment feature may, for example, be provided along the first side surface and another fishing line attachment feature along the second side surface to produce a lure with a single echelon angle setting and single “walk the dog” amplitude. It is also to be understood that more than four fishing line attachment features may be provided along a side surface to produce a lure with more echelon angle settings and more “walk the dog” amplitude settings.

In operation, fishing lure 2200 may be placed on the surface of the water in a stationary position directly behind the tip eye of a fishing rod connected to a stationary boat. As the boat begins moving forward and continues to move forward in a straight line, fishing lure 2200, connected to create an echelon angle of, for example, 40 degrees tracks out to a side until it achieves it pre-selected angle setting. Thereafter, it achieves its greatest walk-the-dog action for the given echelon angle setting. In this echelon position, water resistance acting against at least a side of keel 2226 causes fishing lure 2200 to travel generally parallel to the course of the tip eye of a fishing rod, but not precisely parallel. Rather, the steering affect imparted by the keel causes the fishing lure to steer further away from the course of the tip eye of the fishing rod until the tension force of the fishing line overcomes the steering force. For example, when fishing lure 2200 crests a wave, keel 2226 becomes less engaged with the water and fishing line tension overcomes the steering force of keel 2226, resulting in the proximal end of the fishing lure suddenly moving closer to the course of the tip eye of the fishing rod. As the keel 2226 fully reengages with the water, fishing line tension on fishing lure 2200 is now less than the steering force of the keel and the fishing lure steers back away from the course of the tip eye of the fishing rod. This action repeats, resulting in the walk-the-dog action. Similar walk-the-dog action can result from rocking of the boat, which causes fluctuations in the tension force in the fishing line. In an embodiment, the movement is an erratic, random zigzagging pattern about an echeloning position along a course centerline parallel to the course centerline of the tip eye of the fishing rod and may be described as sometimes a triangle wave pattern, sometimes a sawtooth wave pattern, and sometimes any waveform in between.

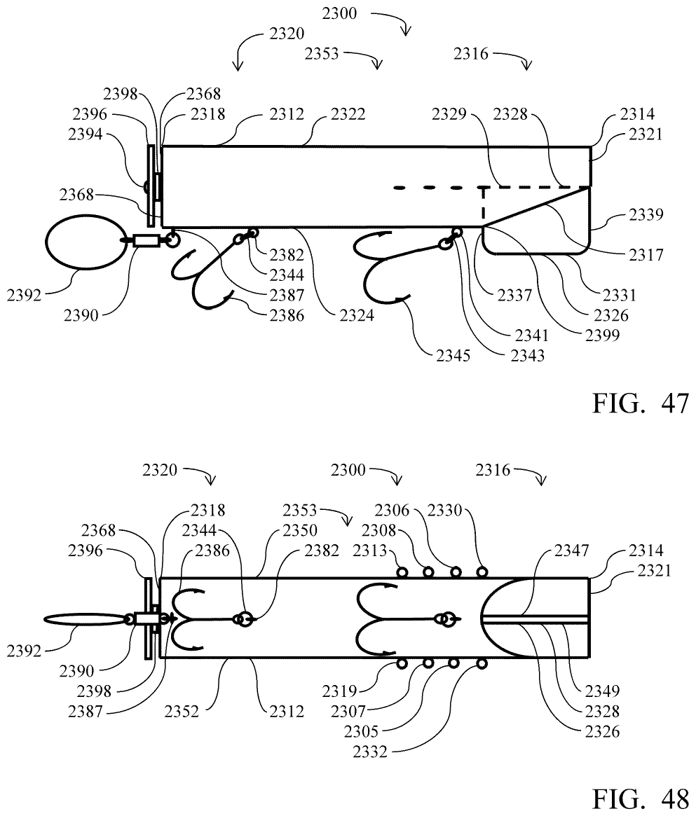

The echeloning zigzagging topwater fishing lure illustrated in FIGS. 47-48 is configured so as to be operable by a user from a port side of a boat or from a starboard side of a boat, depending on the user's preference. The either-handed design of the fishing lure is also useful for anglers desiring to use the fishing lure from either bank of a stream.

The embodiment illustrated in FIGS. 47-48 may be readily understood by realizing that it may be constructed according to FIGS. 44-46, except that instead of a hook attachment feature being provided on the distal end surface with a fishhook (and optionally a split ring) attached thereto, a fastener is provided for attaching a percussion plate and spacer. Additionally, a swivel attachment feature, swivel, and spinner blade are provided.

Referring further to FIGS. 47-48, fishing lure 2300 comprises a partially truncated cylindrical lure body 2312. Lure body comprises a top surface 2322, a bottom surface 2324, a first side surface 2350 extending between top surface 2322 and bottom surface 2324, a second side surface 2352 mirroring and opposed to the first side surface 2350, proximal end 2314, a proximal end surface 2321, a proximal end region 2316, a middle region 2353, a distal end 2318, a distal end surface 2368, a distal end region 2320, a longitudinal axis between proximal end 2314 and distal end 2318, and a vertical axis between top surface 2322 and bottom surface 2324. In an embodiment, the longitudinal axis of the fishing lure 2300 may be substantially equidistant between first side surface 2350 and second side surface 2352 in middle region 2353 and substantially equidistant between top surface 2322 and bottom surface 2324 in middle region 2353.

In an embodiment, lure body 2312 may further comprise a beveled surface. Beveled surface 2317 may adjoin proximal end surface 2321 and in turn adjoin bottom surface 2324. In an embodiment, beveled surface 2317 enables fishing lure 2300 to more readily negotiate waves that the fishing lure may encounter along its course. In an embodiment, beveled surface 2317 may be flat as illustrated, extending from proximal end 2314 to transition point 2399 with the bottom surface 2324. In another embodiment, at least a distal portion of the beveled surface may be curved to provide a smooth, rather than angular, transition into the bottom surface 2324.

The fishing lure 2300 further comprises at least one keel 2326 in the proximal end region 2316. Keel 2326 comprises of a top surface 2329, bottom surface 2331, a proximal end surface 2339, a distal end surface 2337, a first side surface 2347, and a second side surface 2349. A longitudinal axis of keel 2326 extends between proximal end surface 2339 of the keel 2326 and the distal end surface 2337 of the keel 2326. The longitudinal axis of the keel may be substantially parallel the longitudinal axis of the lure body 2312.

A fishhook attachment feature 2341 may be provided in the middle region 2353 of lure body 2312. The fishhook attachment feature 2341 may, for example, be an eye or a loop. A fishhook 2345 may be connected to the fishhook attachment feature directly or indirectly, such as by a split ring 2343. A swivel attachment feature 2387 may be provided along bottom surface 2324 in the distal end region 2320. A swivel 2390 may be attached to swivel attachment feature 2387 at one end and a spinner blade 2392 at its other end. A fishhook attachment feature 2382 may be provided in the distal end region 2320 of lure body 2312. The fishhook attachment feature 2382 may, for example, be an eye or a loop. A fishhook 2386 may be connected to the fishhook attachment feature directly or indirectly, such as by a split ring 2344.

Slot 2328 is formed through at least a portion of lure body 2312 in proximal end region 2316. In an embodiment in which fishing lure 2300 comprises a beveled surface 2317, slot 2328 may continue through a portion of the bottom surface 2324. Slot 2328 is provided to fittingly mount keel 2326 in proximal end region 2316. Slot 2328 is shaped and sized to mate with that portion of keel 2326 inserted thereto. Keel 2326 is positioned in slot 2328 and may be secured to lure body 2312 by press fit, mechanical fasteners, adhesive bonding, or other affixation methods.

At least one fishing line attachment feature 2330 is provided along first side surface 2350. Additional fishing line attachment features 2313, 2308, and/or 2306 may optionally be provided on first side surface 2350. At least one fishing line attachment feature 2319 is provided along second side surface 2352. Additional fishing line attachment features 2332, 2305, and/or 2307 may be provided on second side surface 2352. An additional fishing line attachment feature may optionally be provided on the proximal end surface 2315, so lure may be operated in a conventional, non-echeloning position.

Fastener attachment feature 2394, such as a screw, may be provided on distal end surface 2368 after percussion plate 2396 and spacer 2398 have been slid over its shaft. An example of a suitable percussion plate 2396 is a galvanized steel fender washer with an inner diameter larger than the shaft diameter of fastener attachment feature 2394. An example of a suitable spacer is a galvanized steel flat washer with an inner diameter larger than the shaft diameter of fastener attachment feature 2394. It is to be understood that although the examples of the percussion plate and spacer provided are metals, the percussion plate and/or spacer may, for example, be produced out of other metals, ceramics, composite materials, or any combination thereof.

In operation of the embodiment illustrated in FIGS. 47-48, its echeloning and “walking the dog” operation are substantially similar to the embodiment illustrated in FIGS. 44-46. However, fishing lure 2300 produces a secondary action and a sound. Spinner blade 2392 flutters behind lure body 2312 to add more motion and occasionally strikes percussion plate 2396, thus making a sound audible to fish.

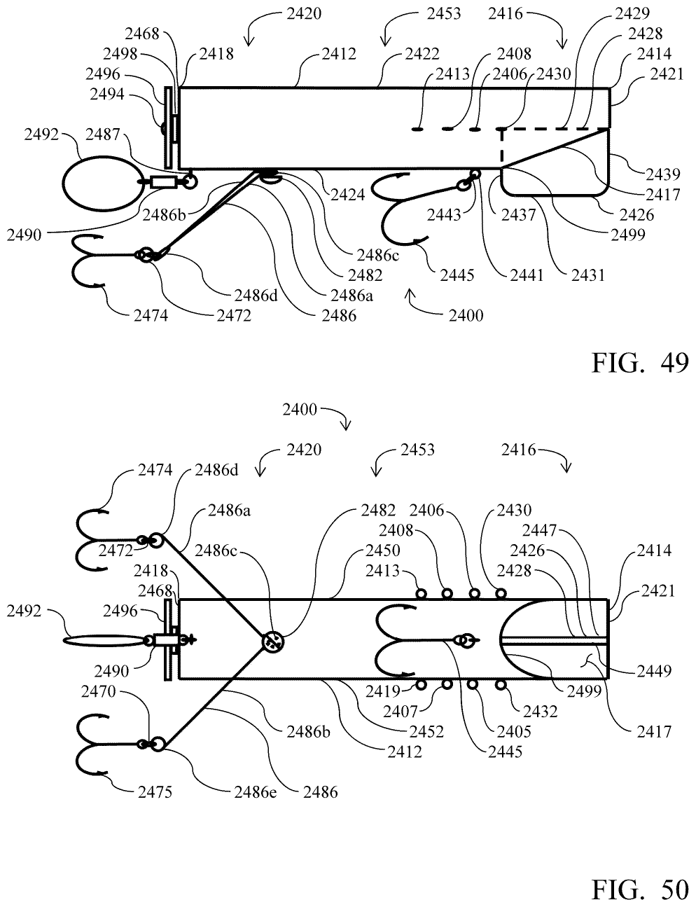

The echeloning zigzagging topwater fishing lure illustrated in FIGS. 49-50 is configured so as to be operable by a user from a port side of a boat or from a starboard side of a boat, depending on the user's preference. The either-handed design of the fishing lure is also useful for anglers desiring to use the fishing lure from either bank of a stream. The embodiment illustrated in FIGS. 49-50 may be readily understood by realizing that it may be constructed according to FIGS. 47-48, except that instead of a hook attachment feature and hook being provided on the bottom surface of the lure body in the distal end region, a hook harness assembly held on by a fastener is provided.

Referring further to FIGS. 49-50, fishing lure 2400 comprises a partially truncated cylindrical lure body 2412 having a top surface 2422, a bottom surface 2424 opposed to top surface 2422, a proximal end 2414, proximal end surface 2421, proximal end region 2416, middle region 2453, distal end 2418, distal end surface 2468, distal end region 2420, a first side surface 2450 extending between top surface 2422 and bottom surface 2424, a second side surface 2452 mirroring and opposed to first side surface 2450, and a distal end surface 2468. In an embodiment, the longitudinal axis of the fishing lure 2400 may be substantially equidistant between top surface 2422 and bottom surface 2424 in middle region 2453 and equidistant between first side surface 2450 and second side surface 2452 in middle region 2453.

In an embodiment, proximal end surface 2421 may adjoin to a beveled surface 2417. Beveled surface in turn may adjoin bottom surface 2424. In an embodiment, beveled surface 2417 enables the fishing lure to more readily negotiate waves without going under the water's surface. In an embodiment, beveled surface 2417 may be angled as illustrated, extending from proximal end 2414 to transition point 2499 with the bottom surface 2424. In another embodiment, at least a distal portion of the beveled surface may be curved to provide a smooth, rather than angular, transition into the bottom surface 2424.

The fishing lure 2400 further comprises at least one keel 2426 in the proximal end region 2416. Keel 2426 comprises of a top surface 2429, bottom surface 2431, a proximal end surface 2439, a distal end surface 2437, a first side surface 2447, and a second side surface 2449. A longitudinal axis of keel 2426 extends between proximal end surface 2439 of the keel 2426 and the distal end surface 2437 of the keel 2426. In an embodiment, the longitudinal axis of the keel may be substantially parallel the longitudinal axis of the lure body 2412.

A fishhook attachment feature 2441 may be provided in the middle region 2453 of lure body 2412. The fishhook attachment feature 2441 may, for example, be an eye or a loop. A fishhook 2445 may be connected to the fishhook attachment feature directly or indirectly, such as by a split ring 2443.

Fishing lure 2400 further comprises a V-shaped harness 2486. Fastener 2482 connects V-shaped harness 2486 to bottom surface 2424 through loop portion 2486c, which extends between first side harness leg portion 2486a and second side harness leg portion 2486b. First side harness leg portion 2486a extends to fishhook attachment portion 2486d, which may be a loop or coil. Fishhook 2474 is provided on fishhook attachment portion 2486d directly or indirectly, such as by a split ring 2472. Second side harness leg portion 2486b extends to fishhook attachment portion 2486e, which may be a loop or a coil. Fishhook 2475 is provided on fishhook attachment portion 2486e directly or indirectly, such as by a split ring 2470. An example of a suitable material from which to construct V-shaped harness 2486 is 0.051 inch diameter model 4421 Looped End Wire Shaft available from lurepartsonline.com.

Slot 2428 is formed in at least a portion of beveled surface 2417 and may continue into a portion of the bottom surface 2424. Slot 2428 is provided to fittingly mount keel 2426 in proximal end region 2416. Slot 2428 is shaped and sized to mate with the portion of keel 2426 inserted thereto. Keel 2426 is positioned in slot 2428 and may be secured to lure body 2412 by press fit, mechanical fasteners, adhesive bonding, or other affixation methods.

At least one fishing line attachment feature 2430 is provided along first side surface 2450. An additional fishing line attachment feature 2413 may optionally be provided on first side surface 2450. At least one fishing line attachment feature 2419 is provided along second side surface 2452. An additional fishing line attachment feature 2432 may be provided on second side surface 2452. An additional fishing line attachment feature may optionally be provided on the proximal end surface 2421, so lure may be operated in a conventional, non-echeloning position. A swivel attachment feature 2487 may be provided on bottom surface 2424. A swivel 2490 may be attached to swivel attachment feature 2487 at one end and a spinner blade 2492 at its other end.

Fastener attachment feature 2494, such as a screw, may be provided on distal end surface 2468 after sliding a percussion plate 2496 and spacer 2498 over its shaft. An example of a suitable percussion plate 2496 is a galvanized steel fender washer with an inner diameter slightly larger than the shaft diameter of fastener attachment feature 2494. An example of a suitable spacer is a galvanized steel flat washer with an inner diameter larger than the shaft diameter of fastener attachment feature 2494. It is to be understood that although the examples of the percussion plate and spacer provided are metals, the percussion plate and/or spacer may, for example, be produced out of other metals, ceramics, composite materials, or any combination thereof.

In operation of the embodiment illustrated in FIGS. 49-50, its echeloning and “walk the dog” action, as well as the clanking sound, of fishing lure 2400 are substantially similar to those of the embodiment illustrated in FIGS. 47-48.

It is to be understood that although the lure bodies illustrated in FIGS. 44-50 are shown as having no diameter taper, at least one region of the lure body may have a taper without departing from the scope or spirit of this disclosure. For example, the distal end region may be tapered such that the diameter of the lure body in a least one location in its distal end region is smaller than the diameter of the lure body in at least one location in its middle region. It is also to be understood that although the proximal end surface and distal end surface are illustrated as meeting the top surface, bottom surface, and side surfaces of the lure body at angles in FIGS. 44-50, the corners may be rounded or beveled. It is also to be understood that although the fishing lures illustrated in FIGS. 44-50 are illustrated as having round cross-sections, other cross-sections are within the spirit and scope of this disclosure. For example, elliptical cross-sections and non-rectangular polygonal cross-sections are also within the spirit and scope of this disclosure. It is also to be understood that although the bevels as illustrated in FIGS. 44-50 are illustrated as flat, they may be curved without departing from the spirit or scope of this disclosure.

An example of material from which the lure bodies illustrated in this disclosure may be fabricated is cedar, though other wood, and/or other materials including plastic may be used alone or in conjunction with wood or other material(s). An example of material from which the keels illustrated in this disclosure may be fabricated is aluminum flat bar, though other materials, including plastic, may be used alone or in combination with other material(s). Other materials may be used without departing from the scope or spirit of this disclosure.

Although the fishing lures illustrated in this disclosure are illustrated as assembled from multiple separate components, it is to be understood that various components may be formed together without departing from the scope or spirit of this disclosure. For example, the keels and lure bodies may be formed together, such as by molding, machining, 3D printing, etc. Another example is that the fishhook attachment features and fishing line attachment features may be molded, machined, 3D printed, etc. into the fishing lure during fabrication of the fishing lure.

It is to be understood that although the fishing lures illustrated in FIGS. 1-28 and FIGS. 41-43 are illustrated as having rectangular cross-sections, the corners may be rounded or beveled without departing from the spirit and scope of the fishing lures disclosed herein. The rounding may produce a lure body having a round or elliptical cross-section in at least a portion of the lure body. The beveling may produce fishing lures having a substantially non-rectangular polygonal cross-section in at least a portion of the lure body.

Some embodiments disclosed herein can be operated from either gunnel of a moving boat. Some embodiments disclosed herein may be operated off a particular gunnel and may be labeled to assist the user. For example, the letters “L” and “R” may be applied to the fishing lures to identify the port (left) side echeloning fishing lures from the starboard (right) side echeloning fishing lures. Fishing lures may be labeled with the average echelon angles they are configured to create during operation; for example, 15, 30, or 45 degrees. Fishing lures may be labeled with the trolling speed at which they are configured to be operated; for example, 1, 2, 3, 4, 5, or 6 miles per hour.

Although the term “fishing rod” was been used throughout this disclosure, other devices for attaching fishing line to a boat may be used without departing from the scope or spirit of this disclosure. Although the term “tip eye” has been used throughout this disclosure, those skilled in the art will appreciate that a “tip eye” of a fishing rod is the most distal point at which a fishing rod contacts a fishing line. Other devices may be substituted for a fishing rod without departing from the scope or spirit of this disclosure.

It is to be understood that although operations of fishing lures disclosed herein have been described while connected to fishing line, the connection to fishing line may be direct or indirect. For example, the connection may be through intermediate devices such as split rings, snaps, leaders, and other intermediate devices without departing from the scope or spirit of this disclosure.

The embodiments above are intended to be illustrative and not limiting. Additional embodiments are within the claims. Although subject matter hereof has been described with reference to particular embodiments, changes may be made in form and detail without departing from the spirit and scope of the subject matter.

Various modifications to subject matter hereof may be apparent upon reading this disclosure. For example, readers will recognize that the various features described in relation to the various embodiments disclosed herein can be suitably combined, un-combined, and re-combined with other features, alone, or in different combinations, within the spirit and scope of the subject matter. Likewise, the various features described above should all be regarded as example embodiments, rather than limitations to the scope or spirit of the subject matter. Therefore, the above is not contemplated to limit the scope of the subject matter.

What is claimed is:

1. An echeloning fishing lure, comprising:
a lure body having a proximal end, a distal end, and a longitudinal axis extending between the proximal end and the distal end of the lure body;
a keel having a proximal end, a distal end, and a longitudinal axis extending between the proximal end and the distal end of the keel;
the longitudinal axis of the keel along or parallel to the longitudinal axis of the lure body;
the lure body having a side surface;
a fishing line attachment feature positioned on the side surface of the lure body;
the fishing line attachment feature connectable to a fishing line connectable to a fishing rod; and
the echeloning fishing lure configured to operate behind and to a side of a tip eye of the fishing rod on a boat moving along a straight line.

2. The echeloning fishing lure of claim 1, wherein the echeloning fishing lure is a topwater lure.

3. The echeloning fishing lure of claim 1, wherein the echeloning fishing lure is configured to follow at least one of an erratic zigzag waveform pattern, a sawtooth waveform pattern, a triangle waveform pattern, or a waveform shape pattern in between those patterns about the centerline of its course in operation without a user manipulating the fishing rod to induce the pattern.

4. The echeloning fishing lure of claim 1, wherein the echeloning fishing lure is configured to create an average echelon angle of between about 10 degrees and about 45 degrees in the operation.

5. The echeloning fishing lure of claim 1, wherein the echeloning fishing lure comprises a plurality of fishing line attachment features and is configured to enable a user to change the average echelon angle the echeloning fishing lure forms in operation by removing the fishing line from one fishing line connection feature and attaching the fishing line to an other fishing line attachment feature.

6. The echeloning fishing lure of claim 1, wherein the fishing lure comprises a lateral axis and is configured so as to operate with an average orientation of its lateral axis perpendicular to a direction of gravity.

7. The echeloning fishing lure of claim 1, wherein the echeloning fishing lure further comprises a balance weight.

8. The echeloning fishing lure of claim 1, wherein the average echelon angle of the fishing lure can be altered by at least one of a fishing lure maker or a user by attaching a tail assembly to the fishing lure.

9. An echeloning submersible fishing lure, comprising:
a lure body comprising:
a proximal end, a distal end, a longitudinal axis extending between the proximal end and the distal end, a proximal end region, two side surfaces, a top surface, a bottom surface, and a lateral axis extending between the side surfaces;
at least one keel in the proximal end region of the echeloning lure body, the at least one keel having a top surface, a bottom surface, and two side surfaces;
at least one of the top surface of the at least one keel extending upwardly beyond the top surface of the lure body or the bottom surface of the at least one keel extending downwardly beyond the bottom surface of the lure body;
at least one fishing line connection feature on at least one of a side surface of the lure body or the at least one keel;
the fishing line attachment feature connectable to a fishing line connectable to a fishing rod;
the echeloning submersible fishing lure configured to operate fully submerged in a position behind and to a side of a tip eye of the fishing rod on a boat moving along a straight line; and
the echeloning submersible fishing lure further configured to operate with the average orientation of its lateral axis substantially perpendicular to a direction of gravity.

10. The echeloning submersible fishing lure of claim 9, wherein the echeloning submersible fishing lure further comprises a balance weight.

11. The echeloning submersible fishing lure of claim 9, wherein the echeloning fishing lure further comprises a roll adjustment feature and is configured to have substantially symmetrical side-to-side rolling action about its longitudinal axis during operation.

12. An echeloning fishing lure, comprising:
a lure body, the lure body having a proximal end, a distal end, at least two side surfaces, the side surfaces opposed to each other, and a lateral axis extending between the side surfaces;
the echeloning fishing lure having a least one keel in the proximal end region, the keel having a side surface;
a fishing line connection feature on at least one of a side surface of the lure body or a side surface of the at least one keel;
the fishing line attachment feature connectable to a fishing line connectable to a fishing rod;
the echeloning fishing lure configured to operate behind and to a side of a tip eye of the fishing rod on a boat moving along a straight line; and
the fishing lure configured to be adjustable to operate with an average orientation of its lateral axis perpendicular to a direction of gravity at a range of pre-selected operating speeds.

13. The echelon fishing lure of claim 12, wherein the lure body further comprises a proximal end region and a bevel in the proximal end region.

14. The echeloning fishing lure of claim 12, wherein the echeloning fishing lure is a topwater fishing lure.

15. The echeloning fishing lure of claim 12, wherein the lure body comprises a top surface and the echeloning fishing lure is configured to submerge due to a force of water moving over the top surface of the lure body.

16. The echeloning fishing lure of claim 12, wherein the echeloning fishing lure is configured to create an average echelon angle of between about 10 degrees and about 45 degrees in the operation.

17. The echeloning fishing lure of claim 12, wherein the echeloning fishing lure further comprises a balance weight.

18. The echeloning fishing lure of claim 12, wherein the echeloning fishing lure is configured to follow at least one of an erratic zigzag waveform pattern, a sawtooth waveform pattern, a triangle waveform pattern, or a waveform shape pattern in between those patterns about the centerline of its course in operation without a user manipulating the fishing rod to induce the pattern.

19. The echeloning fishing lure of claim 12, wherein the echeloning fishing lure comprises a plurality of fishing line attachment features and is configured to enable a user to change an average echelon angle the echeloning fishing lure forms in operation by removing the fishing line from one fishing line connection feature and attaching the fishing line to an other fishing line attachment feature.

20. The echeloning fishing lure of claim 12, wherein the average echelon angle of the fishing lure can be altered by at least one of a fishing lure maker or a user by attaching a tail assembly to the fishing lure.
